(19) United States
(12) Patent Application Publication
(10) Pub. No.: US 2025/0203279 A1
(43) Pub. Date: Jun. 19, 2025

(54) ELECTRONIC APPARATUS AND CONTROLLING METHOD THEREOF

(71) Applicant: SAMSUNG ELECTRONICS CO., LTD., Suwon-si (KR)

(72) Inventor: Yunsung JUNG, Suwon-si (KR)

(73) Assignee: SAMSUNG ELECTRONICS CO., LTD., Suwon-si (KR)

(21) Appl. No.: 19/016,302

(22) Filed: Jan. 10, 2025

Related U.S. Application Data
(63) Continuation of application No. PCT/KR2024/018523, filed on Nov. 21, 2024.

(30) Foreign Application Priority Data
Dec. 18, 2023 (KR) 10-2023-0185104

(51) Int. Cl. H04R 1/32; G05D 1/2285; G06F 3/16

(52) U.S. Cl. CPC H04R 1/323; G05D 1/2285; G06F 3/167; H04R 1/326

(57) ABSTRACT

An electronic apparatus including: a speaker; a microphone; and at least one processor, wherein the at least one processor is configured to identify a candidate region having a critical area or more area than the critical area in map data related to a space where the electronic apparatus is located, move the electronic apparatus to a representative location of the candidate region and output an audio signal through the speaker, acquire a reverberation time of the audio signal at a plurality of locations including the representative location in the candidate region based on a recorded audio signal corresponding to the audio signal and acquired through the microphone, and identify, as a target location, a location from which a longest reverberation time is acquired among the plurality of locations.

### CROSS-REFERENCE TO RELATED APPLICATION

This application is a continuation application, under 35 U.S.C. § 111(a), of international application No. PCT/KR2024/018523, filed on Nov. 21, 2024, which claims priority under 35 U. S. C. § 119 to Korean Patent Application No. 10-2023-0185104, filed on Dec. 18, 2023, the disclosures of which are incorporated herein by reference in their entireties.

### BACKGROUND

### 1. Field

The present disclosure relates to an electronic apparatus and a controlling method thereof, and more particularly, to an electronic apparatus that recognizes a user command and performs a function corresponding to the user command, and a controlling method thereof.

### 2. Description of Related Art

The electronic apparatus may include a microphone to recognize a user command in a specific space. In case of receiving the user command through the microphone, the electronic apparatus may have a recognition rate changed based on the quality of a user voice including the user command.

If a user speaks from a distance, the electronic apparatus may have a low recognition rate based on its location. In addition, if located in a space having a complex structure or a space having many obstacles, the electronic apparatus may have the low voice recognition rate.

A mobile electronic apparatus may stand by for a long time at its charging location. While the mobile electronic apparatus stands by at the charging location, the user may speak and the user voice may call the mobile electronic apparatus. If the recognition rate of the user voice is low at the charging location, the electronic apparatus may have difficulty in accurately performing a function corresponding to the user command, which may lower the user's satisfaction.

There is a need to specify a location where the electronic apparatus may best recognize the user voice in a space where the electronic apparatus is disposed. If the user arbitrarily specifies a location of the electronic apparatus, it may be difficult to determine its most efficient location.

### SUMMARY

The present disclosure provides an electronic apparatus that provides a target location for receiving a user voice in consideration of a reverberation time of an audio signal, and a controlling method thereof.

According to an embodiment of the present disclosure, provided is an electronic apparatus including: a speaker; a microphone; and at least one processor configured to identify a candidate region having a critical area or more area than the critical area in map data related to a space where the electronic apparatus is located, move the electronic apparatus to a representative location of the candidate region and output an audio signal through the speaker, acquire a reverberation time of the audio signal at a plurality of locations including the representative location in the candidate region based on a recorded audio signal corresponding to the audio signal acquired through the microphone, and identify a target location from which a longest reverberation time is acquired among the plurality of locations.

The at least one processor may be configured to identify, as the candidate region, a region in the map data that has the critical area or more area than the critical area among a plurality of regions, and identify the target location in the candidate region.

The at least one processor may be configured to acquire a perimeter length of a first region having the critical area or more area than the critical area, acquire a length corresponding to an open space in the first region, and identify the first region as the candidate region based on the length corresponding to the open space is divided by the perimeter length to acquire a ratio of the open space being less than a critical ratio.

The at least one processor may be configured to acquire a first volume of the audio signal at a first time point based on the recorded audio signal after outputting the audio signal, acquire a second volume by multiplying the first volume by a predetermined reverberation ratio, acquire a second time point at which the audio signal is at the second volume, and acquire the reverberation time based on a difference between the first time point and the second time point.

The at least one processor may be configured to identify a candidate location that has the reverberation time of a critical time or more time than the critical time among the plurality of locations, and identify the target location based on the candidate location and additional information.

The additional information may include a power-supplyable location for connecting power to the electronic apparatus, and the at least one processor may be configured to identify the target location based on the candidate location, which is closest to the power-supplyable location among the plurality of candidate locations, where a distance difference between the candidate location and the power-supplyable location is less than a critical distance.

The additional information may include a candidate projection surface location related to output of a projection image, and the at least one processor may be configured to identify, as the target location, the candidate location closest to the candidate projection surface location.

The recorded audio signal may be a first recorded audio signal, the target location may be a first target location, and the at least one processor may be configured to identify a speaking location of a user command during a critical period, output the audio signal through the speaker based on the speaking location, acquire a second recorded audio signal including the audio signal through the microphone, acquire the reverberation time of the audio signal based on the second recorded audio signal, and identify a second target location that has the longest reverberation time among the plurality of locations, wherein the second target location is different from the first target location.

The apparatus may further include a display, wherein the at least one processor is configured to control the display to display a user interface (UI) including the map data indicating the target location.

The at least one processor may be configured to move the electronic apparatus to the target location based on a predetermined event occurring.

According to an embodiment of the present disclosure, provided is a controlling method of an electronic apparatus, the method including: identifying a candidate region having a critical area or more area than the critical area in map data related to a space where the electronic apparatus is located; moving the electronic apparatus to a representative location of the candidate region and outputting an audio signal; acquiring a recorded audio signal corresponding to the audio signal at a plurality of locations in the candidate region; acquiring a reverberation time of the audio signal at the plurality of locations including the representative location in the candidate region based on the recorded audio signal; and identifying a target location from which a longest reverberation time is acquired among the plurality of locations.

In the identifying of the candidate region, a region in the map data that has the critical area or more area than the critical area among the plurality of regions may be identified as the candidate region, and in the identifying of the target location, the target location may be identified in the candidate region.

In the identifying of the candidate region, a perimeter length of a first region having the critical area or more area than the critical area may be acquired, a length corresponding to an open space in the first region may be acquired, and the first region may be identified as the candidate region if the length corresponding to the open space is divided by the perimeter length to acquire a ratio of the open space that is less than a critical ratio.

In the acquiring of the reverberation time, a first volume of the audio signal may be acquired at a first time point based on the recorded audio signal after the audio signal is output, a second volume may be acquired by multiplying the first volume by a predetermined reverberation ratio, a second time point may be acquired at which the audio signal is at the second volume, and the reverberation time may be acquired based on a difference between the first time point and the second time point.

In the identifying of the target location, the location that has the reverberation time of a critical time or more time than the critical time among the plurality of locations may be identified as the candidate location, and the target location may be identified based on the candidate location and additional information.

The additional information may include a power-supplyable location to connect power to the electronic apparatus, and in the identifying of the target location, the target location is identified as the candidate location, which is closest to the power-supplyable location among a plurality of candidate locations where a distance difference between the candidate location and the power-supplyable location is less than a critical distance may be identified as the target location.

The additional information may include a candidate projection surface location related to output of a projection image, and in the identifying of the target location, the candidate location closest to the candidate projection surface location may be identified as the target location.

The method, in which the recorded audio signal is a first recorded audio signal, and the target location is a first target location, may further include: identifying a speaking location of a user command during a critical period; outputting the audio signal through the speaker based on the speaking location; acquiring a second recorded audio signal including the audio signal through the microphone; acquiring the reverberation time of the audio signal based on the second recorded audio signal; and identifying, as a second target location, the location that has the longest reverberation time among the plurality of locations, wherein the second target location is different from the first target location.

The method may further include displaying a user interface (UI) including the map data indicating the target location.

The method may further include moving the electronic apparatus to the target location if a predetermined event occurs.

### BRIEF DESCRIPTION OF THE DRAWINGS

FIG. 1 is a view for explaining an operation of determining a target location corresponding to an electronic apparatus according to an embodiment.

FIG. 2 is a block diagram showing the electronic apparatus according to an embodiment.

FIG. 3 is a block diagram for explaining a specific configuration of the electronic apparatus of FIG. 2 according to an embodiment.

FIG. 4 is a view for explaining an operation of determining a representative location of a space where the electronic apparatus is located according to an embodiment.

FIG. 5 is a view for explaining an operation of determining the target location in the space where the electronic apparatus is located according to an embodiment.

FIG. 6 is a view for explaining an operation of determining the target location according to an embodiment.

FIG. 7 is a view for explaining an operation of determining the target location by analyzing a reverberation time according to an embodiment.

FIG. 8 is a view for explaining an operation of determining a candidate region by considering a critical area according to an embodiment.

FIG. 9 is a view for explaining an operation of determining the candidate region by using a length ratio of an open space according to an embodiment.

FIG. 10 is a view for explaining an operation of determining the candidate region by using the critical area and the length ratio of the open space according to an embodiment.

FIG. 11 is a view for explaining an operation of acquiring the reverberation time according to an embodiment.

FIG. 12 is a view for explaining the reverberation time according to an embodiment.

FIG. 13 is a view for explaining an operation of determining the target location by using the reverberation time according to an embodiment.

FIG. 14 is a view for explaining an operation of determining the target location by considering a power-supplyable location according to an embodiment.

FIG. 15 is a view for explaining an operation of determining the target location by considering a candidate projection surface location according to an embodiment.

FIG. 16 is a view for explaining an operation of determining the target location by considering the power-supplyable location and the candidate projection surface location according to an embodiment.

FIG. 17 is a view for explaining a screen for providing the target location according to an embodiment.

FIG. 18 is a view for explaining a screen for selecting the target location according to an embodiment.

FIG. 19 is a view for explaining a screen related to setting the target location according to an embodiment.

FIG. 20 is a view for explaining an operation of determining the target location by considering a user speaking history according to an embodiment.

FIG. 21 is a view for explaining an operation of outputting a test audio signal by considering a speaking location according to an embodiment.

FIG. 22 is a view for explaining an operation of determining the target location by considering the speaking location according to an embodiment.

FIG. 23 is a view for explaining a controlling method of an electronic apparatus according to an embodiment.

### DETAILED DESCRIPTION

Hereinafter, the present disclosure is described in detail with reference to the accompanying drawings.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily chosen by an applicant may exist. In this case, the meanings of such terms are mentioned in detail in corresponding description portions of the present disclosure. Therefore, the terms used in the present disclosure need to be defined on the basis of the meanings of the terms and the contents throughout the present disclosure rather than simple names of the terms.

In the specification, an expression “have”, “may have”, “include”, “may include”, or the like, indicates the existence of a corresponding feature (for example, a numerical value, a function, an operation, or a component such as a part), and does not exclude the existence of an additional feature.

An expression, “at least one of A or/and B” may indicate either “A or B”, or “both of A and B.”

Expressions “first”, “second”, or the like, used in the specification may indicate various components regardless of the sequence and/or importance of the components. These expressions are used only to distinguish one component and another component from each other, and do not limit the corresponding components.

In case that any component (for example, a first component) is mentioned to be “(operatively or communicatively) coupled with/to” or “connected to another component (for example, a second component), it is to be understood that any component may be directly coupled to another component or may be coupled to another component through still another component (for example, a third component).

A term of a singular number may include its plural number unless explicitly indicated otherwise in the context. It is to be understood that a term “include”, “formed of”, or the like used in this application specifies the presence of features, numerals, steps, operations, components, parts, or combinations thereof, mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated into at least one module and implemented by at least one processor (not shown), except for a “module” or a “˜er/or” that needs to be implemented by specific hardware.

In the specification, a term “user” may refer to a person using an electronic apparatus or an apparatus (e.g., artificial intelligence electronics) using the electronic apparatus.

Hereinafter, an embodiment of the present disclosure is described in detail with reference to the accompanying drawings.

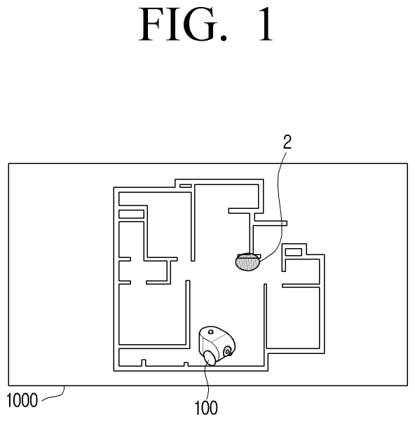

FIG. 1 is a view for explaining an operation of determining a target location corresponding to an electronic apparatus 100 according to an embodiment.

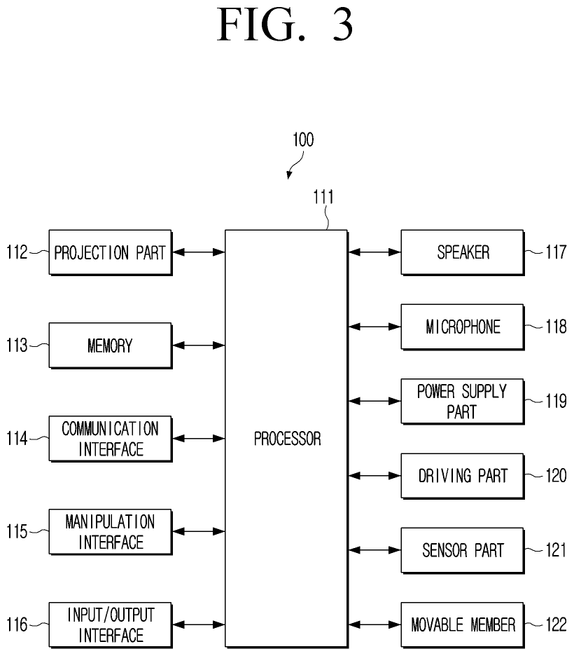

The electronic apparatus 100 may be a mobile device. The electronic apparatus 100 may include a movable member 122 of FIG. 3. The electronic apparatus 100 may be a device movable using the movable member 122. For example, the electronic apparatus 100 may be implemented as a mobile projector or a mobile robot. The mobile robot may be a cleaning robot, a service robot, or the like. Referring to Embodiment 1000 of FIG. 1, the electronic apparatus 100 may determine the target location in a specific space. The target location may be a location suitable for receiving a user voice. The electronic apparatus 100 may receive the user voice through a microphone. The electronic apparatus 100 may clearly recognize the user voice based on its location. The electronic apparatus 100 may be moved to the target location to easily recognize the user voice in the specific space.

The target location may include at least one of a charging location, a standby location, or a placement location. The charging location may be a location for charging the electronic apparatus 100. The charging location may be a location where a charging device (or charging station) for charging the electronic apparatus 100 is disposed. For example, the charging location may be a location where the charging device is disposed to charge a device that needs to be charged, such as the robot or a cordless vacuum cleaner.

The standby location may be a standby location for receiving a user command. The electronic apparatus 100 may stand by in a specific location in a charging mode or a standby mode where the electronic apparatus 100 does not perform a basic function. The electronic apparatus 100 may acquire the user command at the standby location. For example, the robot may be moved to the standby location after performing the user command. The electronic apparatus 100 may wait in the standby location until receiving the user command. A mode may be described as a state or a type.

The placement location may be a location where the electronic apparatus 100 is disposed by a user. For example, if the user needs to directly dispose the electronic apparatus 100, the user may be provided with the placement location of the electronic apparatus 100. For example, the user may be provided with the placement location for disposing a fixed device, such as an artificial intelligence (AI) speaker including the microphone.

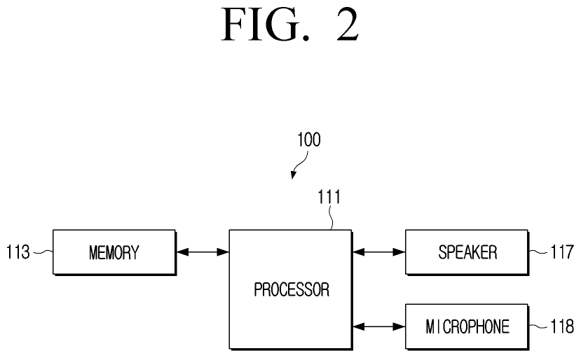

FIG. 2 is a block diagram showing the electronic apparatus 100 according to an embodiment.

Referring to FIG. 2, the electronic apparatus 100 may include at least one of a memory 113, at least one processor 111, a display, a speaker 117, or a microphone 118.

The electronic apparatus 100 may be an electronic whiteboard, a television (TV), a desktop personal computer (PC), a laptop computer, a smartphone, a tablet PC, a server, or the like. The above-described example is only an example to describe the electronic apparatus, and is not necessarily limited to the above-described apparatus.

At least one processor 111 may perform overall control operations of the electronic apparatus 100. At least one processor 111 may function to control overall operations of the electronic apparatus 100.

The memory 113 may store the test audio signal. The memory 113 may store map data related to a space where the electronic apparatus 100 is located. The test audio signal may be described as the audio signal or the output audio signal.

The speaker 117 may output the test audio signal.

The microphone 118 may acquire a recorded audio signal including the test audio signal. The recorded audio signal may include at least one of analog data or converted digital data.

At least one processor 111 may acquire the map data related to the space where the electronic apparatus 100 is located, identify a candidate region having a critical area or more in the map data, determine a representative location representing the candidate region, output the test audio signal stored in the memory 113 through the speaker 117 based on the representative location, acquire the recorded audio signal including the test audio signal through the microphone 118, acquire a reverberation time of the test audio signal based on the recorded audio signal, determine, as the target location, a location in the candidate region that has the longest reverberation time, and provide the target location.

At least one processor 111 may acquire the map data related to the space where the electronic apparatus 100 is located. The map data may include data related to the space where the electronic apparatus 100 is disposed or a space where the electronic apparatus 100 is to travel. The map data may be defined as two-dimensional coordinates or three-dimensional coordinates. The map data may be described as map information, spatial information, spatial data, map feature data, spatial coordinates, or the like.

At least one processor 111 may distinguish a plurality of regions in the map data. At least one processor 111 may distinguish an individual space in the map data as one region. At least one processor 111 may identify the plurality of regions representing the individual spaces in the map data. At least one processor 111 may acquire (or calculate) an area of each of the plurality of regions. At least one processor 111 may identify (or determine), as the candidate region, a region having the critical area (or threshold area) or more.

At least one processor 111 may identify the representative location representing the candidate region. For example, the representative location may be a center point of the candidate region. The representative location may be described as representative coordinates, a reference location, reference coordinates, or the like. For example, one candidate region may have one representative location. For example, one candidate region may have the plurality of representative locations.

At least one processor 111 may output the test audio signal through the speaker 117 based on the representative location.

According to an embodiment, at least one processor 111 may be fixed at the representative location to output the test audio signal.

According to an embodiment, at least one processor 111 may output the test audio signal at the representative location, and continuously output the test audio signal while being moved in the candidate region.

The test audio signal may be the audio signal pre-stored in the memory 113 or the like. The test audio signal may be a signal output to measure the reverberation time. The test audio signal needs to be clearly distinguished in that test audio signal is an analysis target. The test audio signal may include a specific frequency or a specific waveform.

At least one processor 111 may acquire the recorded audio signal including the test audio signal output through the microphone 118. The recorded audio signal may be described as audio data or audio information. The recorded audio signal may include a sound surrounding the electronic apparatus 100. At least one processor 111 may identify the test audio signal from the recorded audio signal.

The test audio signal may be a direct sound or an undirect sound based on a time point at which the test audio signal is recorded through the microphone 118. The undirect sound may indicate a signal that is reflected at least once.

At least one processor 111 may acquire the reverberation time by analyzing the test audio signal included in the recorded audio signal. At least one processor 111 may determine the target location based on the reverberation time.

The reverberation time may be a time in which the audio signal is decreased by a critical ratio compared to its initial output volume (or magnitude). The longer the reverberation time, the smaller the energy loss. The longer the reverberation time, the better the sound may be recognized.

At least one processor 111 may distinguish the plurality of regions in the map data, determine, as the candidate region, the region having the critical area or more among the plurality of regions, and determine the target location in the candidate region.

The critical area may be changed by a user setting. At least one processor 111 may identify one region for each space based on the map data. At least one processor 111 may distinguish the plurality of regions based on the map data. At least one processor 111 may determine the region having the critical area among the plurality of regions as the candidate region. The candidate region may be described as a filtering region or a filtered region.

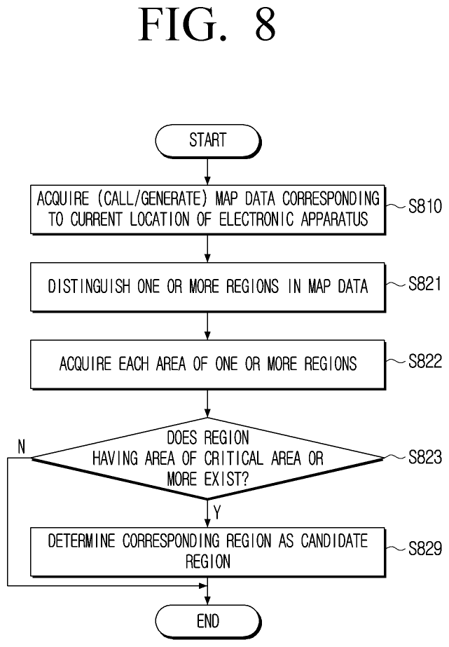

The description describes an operation of determining the candidate region using the critical area with reference to FIG. 8.

At least one processor 111 may acquire a perimeter length of a first region (specific region) having the critical area or more, acquire a length corresponding to an open space in the first region (specific region), acquire a ratio of the open space by dividing the length corresponding to the open space by the perimeter length, determine the first region (specific region) as the candidate region if the ratio of the open space is less than the critical ratio (or threshold ratio).

The specific region may be distinguished as a closed space or an open space. The closed space may be a space where no movement is possible, such as a wall. The open space may be a space where movement is possible, such as a door location. The closed space may be described by a closed part or by a line corresponding to the closed part. The open space may be described by an open part or by a line corresponding to the open part.

At least one processor 111 may acquire the perimeter length that includes both the closed space and the open space in the specific region. The perimeter length may be described as a border length. At least one processor 111 may acquire the length corresponding to the open space.

At least one processor 111 may acquire ratio information based on the perimeter length and the length corresponding to the open space. At least one processor 111 may acquire the ratio information (or ratio value) by dividing the length corresponding to the open space by the perimeter length. The ratio information may indicate a proportion of the open space in the specific region. At least one processor 111 may determine a region where the ratio information is the critical ratio or more as the candidate region.

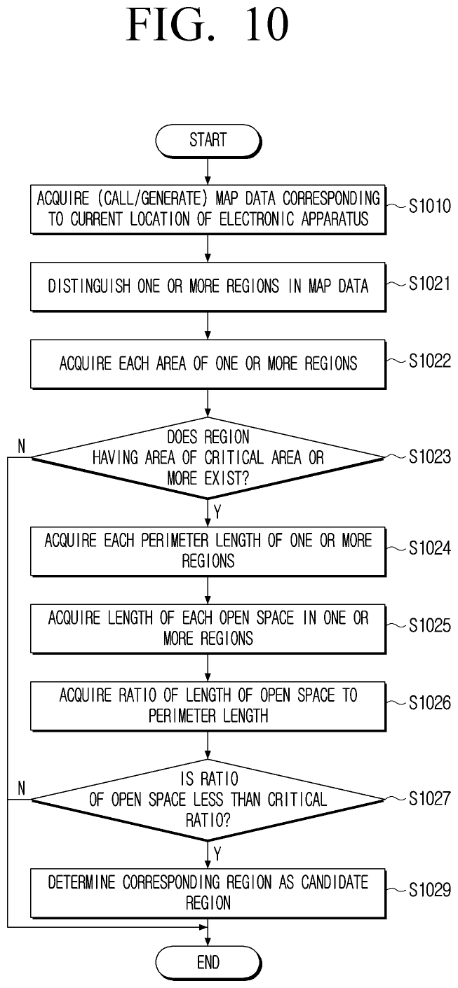

According to various embodiments, the description describes an operation of determining the candidate region using the critical area and the critical ratio with reference to FIG. 10.

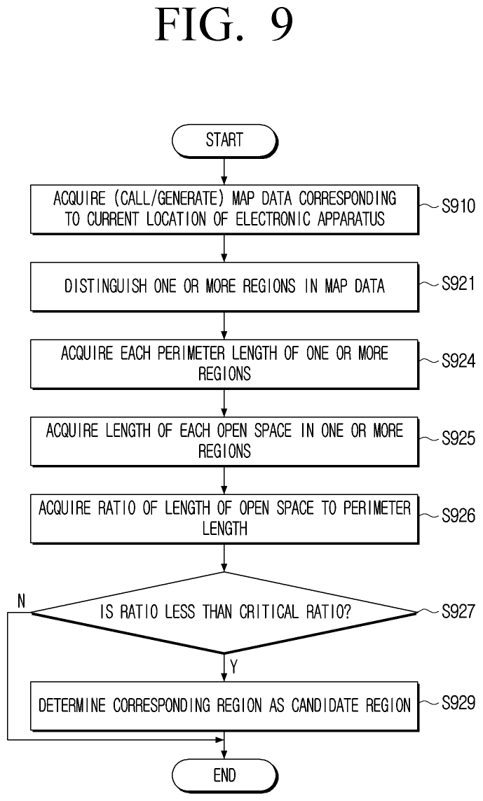

According to the various embodiments, the description describes an operation of determining the candidate region using the critical ratio with reference to FIG. 9.

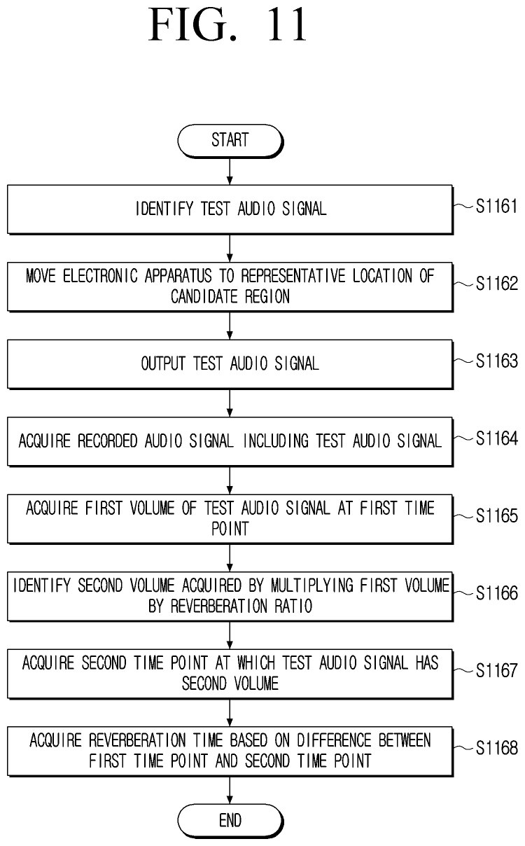

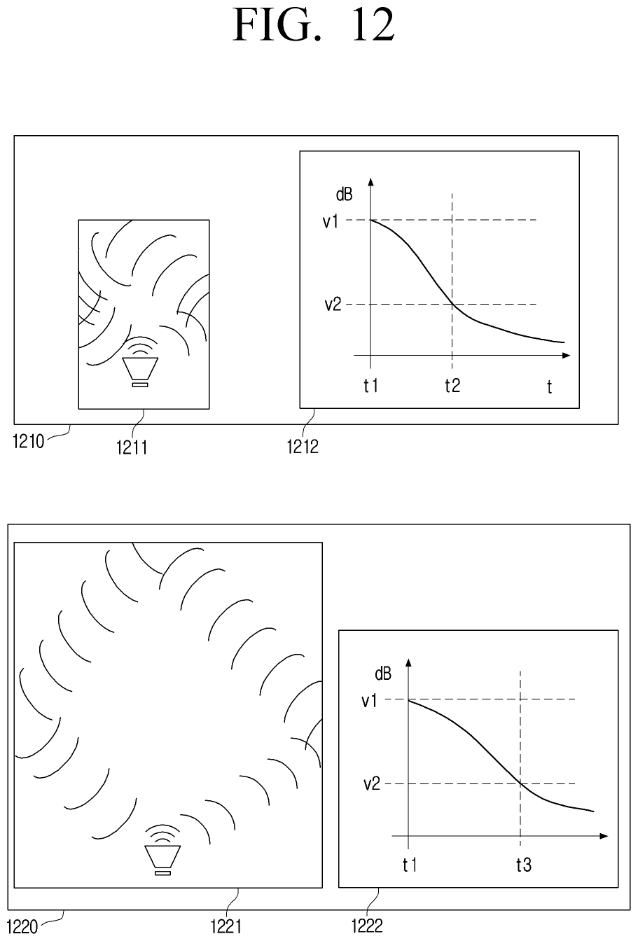

At least one processor 111 may acquire a first volume of the test audio signal at a first time point based on the recorded audio signal after outputting the test audio signal, acquire a second volume by multiplying the first volume by a predetermined reverberation ratio, acquire a second time point at which the volume of the test audio signal becomes a second volume, and acquire the reverberation time based on a difference between the first time point and the second time point. The description thereof is provided with reference to FIGS. 11 and 12.

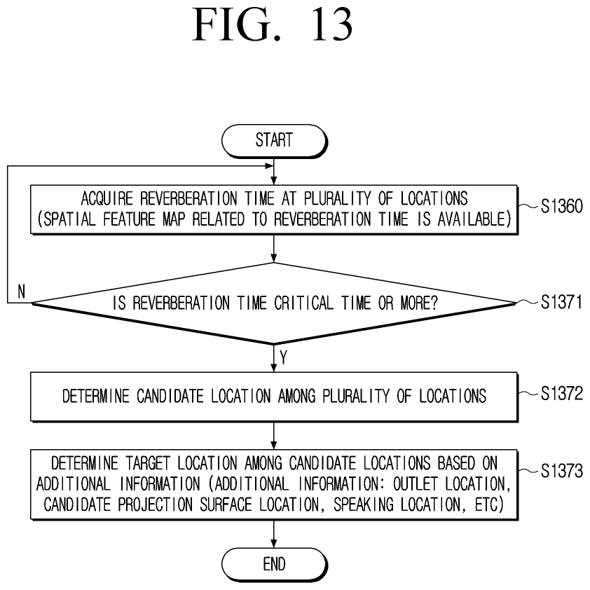

At least one processor 111 may determine, as a candidate location, a location in the candidate region that has the reverberation time of a critical time (or threshold time) or more, and determine the target location based on the candidate location and additional information. A description thereof is provided with reference to FIG. 13.

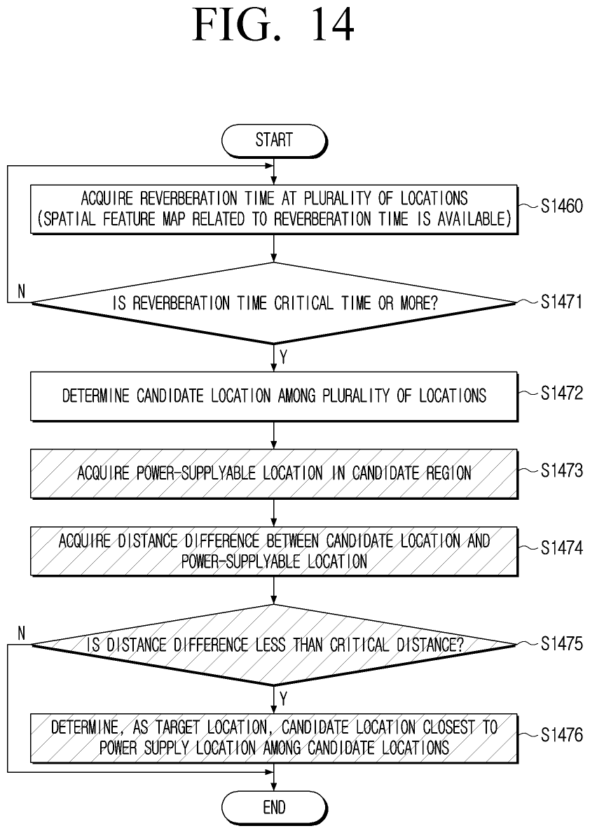

The additional information may include a power-supplyable location for connecting power to the electronic apparatus 100, and at least one processor 111 may acquire a distance difference between the candidate location and the power-supplyable location, and determine, as the target location, the candidate location closest to the power-supplyable location among the plurality of candidate locations where the distance difference is less than a critical distance. A description thereof is provided with reference to FIG. 14.

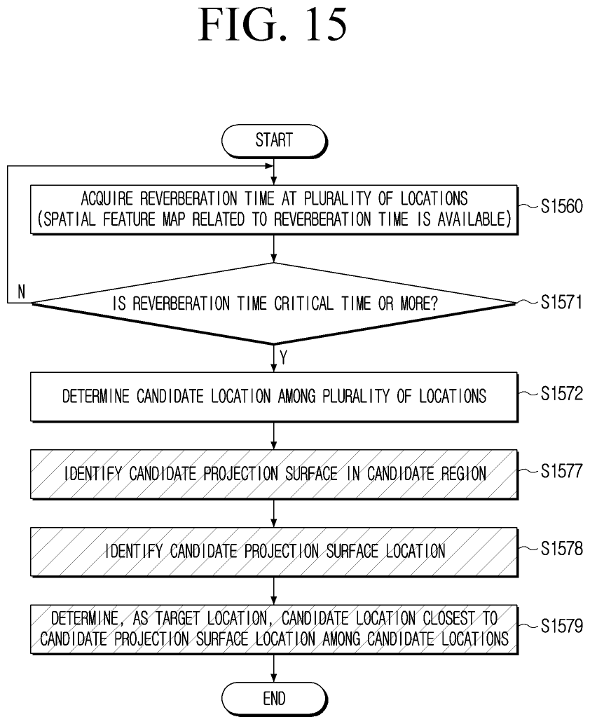

The additional information may include a candidate projection surface location related to output of a projection image, and at least one processor 111 may determine, as the target location, the candidate location closest to the candidate projection surface location. A description thereof is provided with reference to FIG. 15.

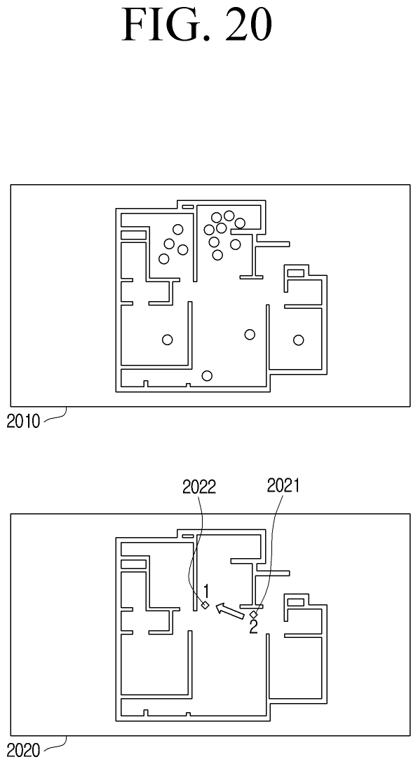

The recorded audio signal may be a first recorded audio signal, and the target location may be a first target location. At least one processor 111 may identify the speaking location of the user command during a critical period, output the test audio signal through the speaker 117 based on the speaking location, acquire a second recorded audio signal including the test audio signal through the microphone 118, acquire the reverberation time of the test audio signal based on the second recorded audio signal, and determine, as a second target location, the location in the candidate region that has the longest reverberation time, wherein the second target location may be different from the first target location. A description related to the speaking location is provided with reference to FIGS. 20, 21, and 22.

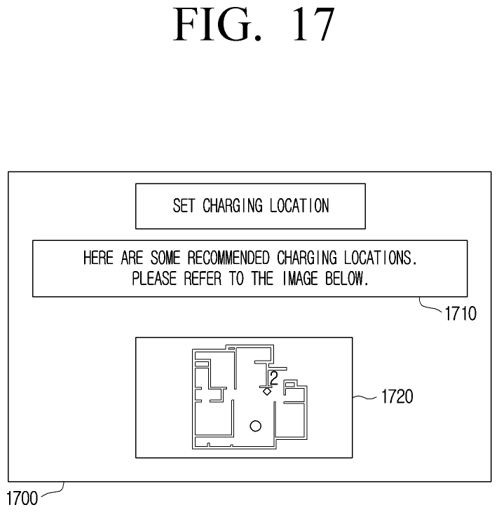

Meanwhile, the electronic apparatus 100 may further include the display. At least one processor 111 may control the display to display a user interface (UI) including the map data indicating the target location. The description thereof is provided with reference to FIGS. 17, 18, and 19.

At least one processor 111 may the electronic apparatus 100 to the target location if a predetermined event occurs.

The predetermined event may include at least one of an event of receiving a control command to move the electronic apparatus 100, an event of recognizing a wake-up word to call the electronic apparatus 100, an event where charging power is less than a critical value, or an event of failing to recognize the user voice.

The electronic apparatus 100 may determine the target location having a relatively long reverberation time using the test audio signal. The target location may be a location where the audio signal is well recognized on average.

The user may easily recognize the location where the audio signal is best heard using the target location. The user may determine the charging location, the standby location, the placement location, or the like by considering the location where the audio signal is well recognized.

According to the various embodiments, the electronic apparatus 100 may be the mobile device. For example, the electronic apparatus 100 may be the mobile robot. For example, the electronic apparatus 100 may be a mobile cleaning robot. For example, the electronic apparatus 100 may be the mobile projector.

The electronic apparatus 100 may include the movable member. The movable member may be controlled by a driving part. The electronic apparatus 100 may transmit power generated from a motor to the movable member through the driving part. The electronic apparatus 100 may be moved to the specific location using the movable member.

If implemented as the projector, the electronic apparatus 100 may include a projection part outputting the projection image.

FIG. 3 is a block diagram for explaining a specific configuration of the electronic apparatus 100 of FIG. 2 according to an embodiment.

Referring to FIG. 3, the electronic apparatus 100 may include at least one of at least one processor 111, a projection part 112, the memory 113, a communication interface 114, a manipulation interface 115, an input/output interface 116, the speaker 117, the microphone 118, a power supply part 119, a driving part 120, a sensor part 121, or the movable member 122.

The configurations shown in FIG. 3 are only the various embodiments, and some configurations may be omitted or new configurations may be added.

The description omits a content already described with reference to FIG. 2.

At least one processor 111 may be implemented as a digital signal processor (DSP) that processes a digital signal, a microprocessor, or a time controller (TCON). However, the processor 111 is not limited thereto, and may include at least one of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machine (ARM) processor, or may be defined by these terms. At least one processor 111 may be implemented as a system-on-chip (SoC), in which a processing algorithm is embedded, a large scale integration (LSI), or may be implemented in the form of a field programmable gate array (FPGA). At least one processor 111 may perform various functions by executing computer executable instructions stored in the memory 113.

The projection part 112 is a component projecting an image to the outside. The projection part 112 according to the various embodiments of the present disclosure may be implemented as various projection types (e.g., cathode-ray tube (CRT) type, liquid crystal display (LCD) type, digital light processing (DLP) type, or laser type). For example, the CRT type may basically be the same as a CRT monitor. The CRT type may display the image on a screen by magnifying the image by using a lens in front of a cathode-ray tube (CRT). According to the number of cathode-ray tubes, the CRT type may be divided into a one-tube type and a three-tube type, and the three-tube type may be implemented while the cathode-ray tubes of red, green, and blue are separated from one another.

As another example, the LCD type may display the image by allowing light emitted from a light source to pass through a liquid crystal. The LCD type may be divided into a single-panel type and a three-panel type. In case of the three-panel type, light emitted from the light source may be separated into red, green and blue in a dichroic mirror (which is a mirror that reflects only light of a specific color and allows the rest to pass therethrough), may then pass through the liquid crystal, and may then be collected into one place again.

As still another example, the DLP type may display the image by using a digital micromirror device (DMD) chip. The DLP type projection part may include a light source, a color wheel, the DMD chip, a projection lens, or the like. Here, light output from the light source may be colored as passing through a rotating color wheel. Light passed through the color wheel may be input into the DMD chip. The DMD chip may include numerous micromirrors and reflect light input into the DMD chip. The projection lens may perform a function of magnifying the light reflected from the DMD chip into an image size.

As yet another example, the laser type may include a diode pumped solid state (DPSS) laser and a galvanometer. The laser type that outputs various colors may use a laser in which three DPSS lasers are respectively installed for red, green, and blue (RGB) colors, and their optical axes then overlap with each other by using a special mirror. The galvanometer may include a mirror and a high-power motor to move the mirror at a high speed. For example, the galvanometer may rotate the mirror at up to 40 KHz/sec. The galvanometer may be mounted in a scanning direction. In general, the projector may perform a flatbed scanning, and the galvanometer may thus also be divided into x and y axes.

The projection part 112 may include light sources of various types. For example, the projection part 112 may include at least one light source of a lamp, a light emitting diode (LED), or a laser.

The projection part 112 may output the image in a screen ratio of 4:3, a screen ratio of 5:4, and a wide screen ratio of 16:9, based on a purpose of the electronic apparatus 100, the user setting, or the like, and may output the image having various resolutions such as wide video graphics array (WVGA, 854*48 pixels), super video graphics array (SVGA, 800*600 pixels), extended graphics array (XGA, 1024*768 pixels), wide extended graphics array (WXGA, 1280*720 pixels), WXGA (1280*800 pixels), super extended graphics array (SXGA, 1280*1024 pixels), ultra extended graphics array (UXGA, 1600*1200 pixels) and full high-definition (full HD, 1920*1080 pixels), based on the screen ratio.

The projection part 112 may perform various functions to adjust the output image under control of at least one processor 111. For example, the projection part 112 may perform a zoom function, a keystone function, a quick corner (four corner) keystone function, a lens shift function, and the like.

In detail, the projection part 112 may enlarge or reduce the image based its distance (i.e., projection distance) to the screen. That is, the projection part 112 may perform the zoom function based on the distance from the screen. Here, the zoom function may include a hardware method of adjusting a screen size by moving the lens, and a software method of adjusting the screen size by cropping the image, or the like. In case of performing the zoom function, the projection part 112 may be required to adjust a focus of the image. For example, a method of adjusting the focus may include a manual focusing method, an electric focusing method, or the like. The manual focusing method may indicate a method of manually adjusting the focus, and the electric focusing method may indicate a method in which the projector automatically adjusts the focus by using a motor built therein in case of performing the zoom function. In case of performing the zoom function, the projection part 112 may provide a digital zoom function by using software, and may provide an optical zoom function in which the zoom function is performed by moving the lens by using the driving part 120.

The projection part 112 may perform the keystone correction function. In case that a height does not match a front projection, the screen may be distorted up or down. The keystone correction function is a function of correcting the screen distortion. For example, in case that the distortion occurs on the screen in a horizontal direction, the distortion may be corrected using a horizontal keystone, and in case that the distortion occurs on the screen in a vertical direction, the distortion may be corrected using a vertical keystone. The quick corner (four corner) keystone correction function is a function of correcting the screen in case that a center region of the screen is normal and its corner region is not balanced. The lens shift function is a function of moving the screen as it is in case that the screen is off-screen.

The projection part 112 may provide the zoom/keystone/focusing functions by automatically analyzing a surrounding environment and a projection environment without a user input. In detail, the projection part 112 may automatically provide the zoom/keystone/focusing functions, based on a distance between the electronic apparatus 100 and the screen, information on a space where the electronic apparatus 100 is currently located, information on an amount of ambient light, or the like, detected by the sensor (e.g., depth camera, distance sensor, infrared sensor, or illuminance sensor).

The projection part 112 may provide an illumination function by using the light source. In particular, the projection part 112 may provide the illumination function by outputting the light source by using the LED. According to the various embodiments, the projection part 112 may include one LED, and according to other embodiments, the electronic apparatus 100 may include the plurality of LEDs. The projection part 112 may output the light source by using a surface-emitting LED according to an implementation example. The surface-emitting LED may be an LED in which an optical sheet is disposed on an upper side of the LED for the light source to be evenly distributed and output. In detail, in case that the light source is output through the LED, the light source may be evenly distributed through the optical sheet and the light source distributed through the optical sheet may be incident on a display panel.

The projection part 112 may provide the user with a dimming function of adjusting intensity of the light source. In detail, in case of receiving the user input for adjusting the intensity of the light source from the user through the manipulation interface 115 (for example, a touch display button or dial), the projection part 112 may control the LED to output the intensity of the light source that corresponds to the received user input.

The projection part 112 may provide the dimming function based on a content analyzed by at least one processor 111 without the user input. In detail, the projection part 112 may control the LED to output the intensity of the light source based on information (e.g., content type or content brightness) on the currently-provided content.

The projection part 112 may control a color temperature under the control of at least one processor 111. At least one processor 111 may control the color temperature based on the content. In detail, in case of identifying the content to be output, at least one processor 111 may acquire frame-by-frame color information of the content whose output is determined. In addition, at least one processor 111 may control the color temperature based on the acquired frame-by-frame color information. At least one processor 111 may acquire at least one primary color of a frame based on the frame-by-frame color information. In addition, at least one processor 111 may adjust the color temperature based on at least one acquired primary color. For example, the color temperature that at least one processor 111 may adjust may be distinguished into a warm type or a cold type. Assume that a frame to be output (hereinafter, an output frame) includes a scene where a fire occurs. At least one processor 111 may identify (or acquire) that the primary color is red based on the color information included in a current output frame. In addition, at least one processor 111 may identify the color temperature corresponding to the identified primary color (red color). The color temperature corresponding to the red color may be the warm type. At least one processor 111 may use an artificial intelligence (AI) model to acquire the color information for the frame or the primary color. According to the various embodiments, the artificial intelligence model may be stored in the electronic apparatus 100 (e.g., memory 113). According to other embodiments, the artificial intelligence model may be stored in an external server that may communicate with the electronic apparatus 100.

The memory 113 may be implemented as an internal memory such as a read-only memory (ROM, e.g., electrically erasable programmable read-only memory (EEPROM)) or a random access memory (RAM), included in at least one processor 111, or as a memory separate from at least one processor 111. In this case, the memory 113 may be implemented in the form of a memory embedded in the electronic apparatus 100 or in the form of a memory detachable from the electronic apparatus 100, based on a data storage purpose. For example, data for driving the electronic apparatus 100 may be stored in the memory embedded in the electronic apparatus 100, and data for an extension function of the electronic apparatus 100 may be stored in the memory detachable from the electronic apparatus 100.

Meanwhile, the memory embedded in the electronic apparatus 100 may be implemented as at least one of a volatile memory (e.g., dynamic RAM (DRAM), static RAM (SRAM) or synchronous dynamic RAM (SDRAM)) or a non-volatile memory (e.g., one time programmable ROM (OTPROM), programmable ROM (PROM), erasable and programmable ROM (EPROM), electrically erasable and programmable ROM (EEPROM), a mask ROM, a flash ROM, a flash memory (e.g., NAND flash or NOR flash), a hard drive, or a solid state drive (SSD)); and the memory detachable from the electronic apparatus 100 may be implemented as a memory card (e.g., compact flash (CF), secure digital (SD), micro secure digital (Micro-SD), mini secure digital (mini-SD), extreme digital (xD), or multi-media card (MMC)), an external memory which may be connected to a universal serial bus (USB) port (e.g., USB memory), or the like.

The memory 113 may store at least one instruction on the electronic apparatus 100. In addition, the memory 113 may store an operating system (O/S) for driving the electronic apparatus 100. The memory 113 may store various software programs or applications for operating the electronic apparatus 100 according to the various embodiments of the present disclosure. In addition, the memory 113 may include a semiconductor memory such as a flash memory, or a magnetic storing medium such as a hard disk.

In detail, the memory 113 may store various software modules for operating the electronic apparatus 100 according to the various embodiments of the present disclosure, and at least one processor 111 may allow the various software modules stored in the memory 113 to be executed to control the operation of the electronic apparatus 100. That is, the memory 113 may be accessed by at least one processor 111, and at least one processor 111 may perform readout, recording, correction, deletion, update and the like of data in the memory 113.

In the present disclosure, the term “memory 113” may include a storage device, a read only memory (ROM) or a random access memory (RAM), disposed in at least one processor 111, or a memory card (for example, a micro secure digital (SD) card or a memory stick) mounted on the electronic apparatus 100.

The communication interface 114 may be a component that communicates with the various types of external devices by using various types of communication methods. The communication interface 114 may include a wireless communication module or a wired communication module. Each communication module may be implemented in the form of at least one hardware chip.

The wireless communication module may be a module that communicates with the external device in a wireless manner. For example, the wireless communication module may include at least one of a wireless-fidelity (Wi-Fi) module, a Bluetooth module, an infrared communication module, or other communication modules.

The Wi-Fi module and the Bluetooth module may respectively perform the communication in a Wi-Fi manner and a Bluetooth manner. In case of using the Wi-Fi module or the Bluetooth module, the communication interface may first transmit and receive various connection information such as a service set identifier (SSID) or a session key, connect the communication by using this connection information, and then transmit and receive various information.

The infrared communication module may perform the communication based on infrared data association (IrDA) technology that transmits data in a short distance in the wireless manner by using an infrared ray between a visible ray and a millimeter wave.

In addition to the above-described communication manners, other communication modules may include at least one communication chip performing the communication based on various wireless communication standards such as zigbee, third generation (3G), third generation partnership project (3GPP), long term evolution (LTE), LTE advanced (LTE-A), fourth generation (4G), and fifth generation (5G).

The wired communication module may be a module communicating with the external device in a wired manner. For example, the wired communication module may include at least one of a local area network (LAN) module, an Ethernet module, a pair cable, a coaxial cable, an optical fiber cable, or an ultra wide-band (UWB) module.

The manipulation interface 115 may include various types of input devices. For example, the manipulation interface 115 could include a physical button. Here, the physical button may include a function key, a direction key (e.g., a four-direction key), or a dial button. According to the various embodiments, the physical button may be implemented as a plurality of keys. According to another embodiment, the physical button may be implemented as one key. In case that the physical button is implemented as one key, the electronic apparatus 100 may receive the user input in which one key is pressed for a critical time or longer. In case of receiving the user input in which one key is pressed for the critical time or longer, at least one processor 111 may perform a function corresponding to the user input. For example, at least one processor 111 may provide the illumination function based on the user input.

The manipulation interface 115 may receive the user input by using a non-contact manner. In case of receiving the user input by using a contact manner, a physical force may be required to be transmitted to the electronic apparatus 100. There may thus be a need for a method of controlling the electronic apparatus 100 regardless of the physical force. In detail, the manipulation interface 115 may receive a user gesture and may perform an operation corresponding to the received user gesture. The manipulation interface 115 may receive the user gesture through the sensor (for example, an image sensor or the infrared sensor).

The manipulation interface 115 may receive the user input by using a touch method. For example, the manipulation interface 115 may receive the user input by using a touch sensor. According to the various embodiments, the touch method may be implemented in the non-contact manner. For example, the touch sensor may determine whether a user body approaches within the critical distance. The touch sensor may identify the user input even in case that the user does not touch the touch sensor. According to another implementation example, the touch sensor may identify the user input where the user touches the touch sensor.

The electronic apparatus 100 may receive the user input in various ways other than the manipulation interface 115 described above. In the various embodiments, the electronic apparatus 100 may receive the user input through an external remote control device. The external remote control device may be a remote control device corresponding to the electronic apparatus 100 (for example, a dedicated control device of the electronic apparatus 100) or a user portable communication device (for example, a smartphone or a wearable device). Here, the user portable communication device may store an application for controlling the electronic apparatus 100. The portable communication device may acquire the user input from the application stored therein, and transmit the acquired user input to the electronic apparatus 100. The electronic apparatus 100 may receive the user input from the portable communication device and perform an operation corresponding to the user control command.

The electronic apparatus 100 may receive the user input by using voice recognition. According to the various embodiments, the electronic apparatus 100 may receive the user voice through the microphone included in the electronic apparatus 100. According to another embodiment, the electronic apparatus 100 may receive the user voice from the microphone or the external device. In detail, the external device may acquire the user voice through the microphone of the external device, and transmit the acquired user voice to the electronic apparatus 100. The user voice received from the external device may be the audio data or the digital data converted from the audio data (e.g., audio data converted to a frequency domain). The electronic apparatus 100 may perform an operation corresponding to the received user voice. In detail, the electronic apparatus 100 may receive the audio data corresponding to the user voice through the microphone. In addition, the electronic apparatus 100 may convert the received audio data into the digital data. In addition, the electronic apparatus 100 may convert the converted digital data into text data by using a speech-to-text (STT) function. According to the various embodiments, the speech-to-text (STT) function may be performed directly by the electronic apparatus 100.

According to another embodiment, the speech-to-text (STT) function may be performed by an external server. The electronic apparatus 100 may transmit the digital data to the external server. The external server may convert the digital data into the text data, and acquire control command data based on the converted text data. The external server may transmit the control command data (here, the text data may also be included) to the electronic apparatus 100. The electronic apparatus 100 may perform an operation corresponding to the user voice, based on the acquired control command data.

The electronic apparatus 100 may provide a voice recognition function by using one assistance (or an AI assistant such as Bixby™), which is only one of the various embodiments. The electronic apparatus 100 may provide the voice recognition function by using a plurality of assistance. Here, the electronic apparatus 100 may provide the voice recognition function by selecting one of the plurality of assistance based on a trigger word corresponding to the assistance or a specific key included in a remote controller.

The electronic apparatus 100 may receive the user input by using screen interaction. The screen interaction may indicate a function of the electronic apparatus 100 to identify whether a predetermined event occurs through the image projected on the screen (or the projection surface), and acquire the user input based on the predetermined event. The predetermined event may indicate an event of identifying a predetermined object at the specific location (for example, a location where an UI for receiving the user input is projected). The predetermined object may include at least one of a user body part (for example, a finger), a pointer, or a laser point. The electronic apparatus 100 may identify that the user input for selecting the projected UI is received in case that the predetermined object is identified at the location corresponding to the projected UI. For example, the electronic apparatus 100 may project a guide image to display the UI on the screen. In addition, the electronic apparatus 100 may identify whether the user selects the projected UI. In detail, the electronic apparatus 100 may identify that the user selects the projected UI if the predetermined event is identified at the location of the projected UI. The projected UI may include at least one item. The electronic apparatus 100 may perform spatial analysis to identify whether the predetermined event occurs at the location of the projected UI. The electronic apparatus 100 may perform the spatial analysis through the sensor (for example, the image sensor, the infrared sensor, the depth camera, or the distance sensor). The electronic apparatus 100 may identify whether the predetermined event occurs at the specific location (where the UI is projected) by performing the spatial analysis. In addition, in case of identifying that the predetermined event occurs at the specific location (where the UI is projected), the electronic apparatus 100 may identify that the user input for selecting the UI corresponding to the specific location is received.

The input/output interface 116 is a component inputting and outputting at least one of the audio signal or an image signal. The input/output interface 116 may receive at least one of the audio signal or the image signal from the external device, and output the control command to the external device.

According to an implementation example, the input/output interface 116 may be implemented as an interface inputting and outputting only the audio signal and an interface inputting and outputting only the image signal, or implemented as one interface inputting and outputting both the audio signal and the image signal.

In the various embodiments of the present disclosure, the input/output interface 116 may be implemented as a wired input/output interface of at least one of a high definition multimedia interface (HDMI), a mobile high-definition link (MHL), a universal serial bus (USB), a USB C-type, a display port (DP), a thunderbolt, a video graphics array (VGA) port, a red-green-blue (RGB) port, a D-subminiature (D-SUB), or a digital visual interface (DVI). According to the various embodiments, the wired input/output interface may be implemented as the interface inputting and outputting only the audio signal and the interface inputting and outputting only the image signal, or implemented as one interface inputting and outputting both the audio signal and the image signal.

The electronic apparatus 100 may receive the data by using the wired input/output interface, which is only one of the various embodiments. The electronic apparatus 100 may receive power by using the wired input/output interface. For example, the electronic apparatus 100 may receive power from an external battery by using the USB C-type or receive power from an outlet by using a power adapter. As still another example, the electronic apparatus 100 may receive power from the external device (e.g., laptop computer or monitor) by using the display port (DP).

The audio signal may be input through the wired input/output interface, and the image signal may be input through the wireless input/output interface (or the communication interface). Alternatively, the audio signal may be input through the wireless input/output interface (or the communication interface), and the image signal may be input through the wired input/output interface.

The speaker 117 is a component outputting the audio signal. In particular, the speaker 117 may include an audio output mixer, an audio signal processor, and an audio output module. The audio output mixer may mix the plurality of audio signals to be output into at least one audio signal. For example, the audio output mixer may mix an analog audio signal and another analog audio signal (e.g., analog audio signal received from the outside) into at least one analog audio signal. The audio output module may include the speaker or an output terminal. According to the various embodiments, the audio output module may include the plurality of speakers. In this case, the audio output module may be disposed in a body of the speaker 117, and audio emitted while covering at least a portion of a diaphragm of the audio output module may pass through a waveguide to be transmitted outside the body. The audio output module may include a plurality of audio output units, and the plurality of audio output units may be arranged on an appearance of the body to be symmetric to each other, and accordingly, the audio may be emitted to all directions, i.e., all directions in 360 degrees.

The microphone 118 is a component receiving the user voice or other sounds, and converting the same into the audio data. The microphone 118 may receive the user voice while activated. For example, the microphone 118 may be integrated with the upper, front, side, or the like of the electronic apparatus 100. The microphone 118 may include various components such as a microphone collecting the user voice in an analog form, an amplifier circuit amplifying the collected user voice, an analog to digital (A/D) conversion circuit sampling the amplified user voice and converting the same into the digital signal, a filter circuit removing a noise component from the converted digital signal, and the like.

The power supply part 119 may receive power from the outside and supply power to the various components of the electronic apparatus 100. The power supply part 119 according to the various embodiments of the present disclosure may receive power by using various methods. The power supply part 119 according to the various embodiments may receive power by using a connector. The power supply part 119 may receive power by using a direct current (DC) power cord of 220 V. However, the electronic apparatus 100 is not limited thereto, and may receive power by using a USB power cord or may receive power by using a wireless charging method.

The power supply part 119 may receive power by using an internal battery or the external battery. The power supply part 119 according to the various embodiments of the present disclosure may receive power by using the internal battery. For example, the power supply part 119 may charge power of the internal battery by using at least one of the DC power cord of 220 V, the USB power cord, or a USB C-Type power cord, and may receive power by using the charged internal battery. The power supply part 119 according to the various embodiments of the present disclosure may receive power by using the external battery. For example, the power supply part 119 can receive power by using the external battery in case that the electronic apparatus 100 and the external battery are connected to each other by using various wired communication methods such as the USB power cord, the USB C-Type power cord and a socket groove. That is, the power supply part 119 may receive power directly from the external battery, or charge the internal battery by using the external battery and then receive power from the charged internal battery.

The power supply part 119 according to the present disclosure may receive power by using at least one of the plurality of power supplying methods described above.

With respect to power consumption, the electronic apparatus 100 may have power consumption of a predetermined value (e.g., 43 W) or less due to a socket type, another standard, or the like. Here, the electronic apparatus 100 may change the power consumption to reduce the power consumption in case of using the battery. That is, the electronic apparatus 100 may change the power consumption based on the power supply method, power usage, or the like.

The driving part 120 may drive at least one hardware component included in the electronic apparatus 100. The driving part 120 may generate the physical force and transmit the same to at least one hardware component included in the electronic apparatus 100.

The driving part 120 may generate driving power for a movement of the hardware component included in the electronic apparatus 100 (for example, a movement of the electronic apparatus 100) or a rotation operation of the component (for example, a rotation of the projection lens).

The driving part 120 may adjust a projection angle of the projection part 112. The driving part 120 may move the location of the electronic apparatus 100. The driving part 120 may control the movable member to move the electronic apparatus 100. For example, the driving part 120 may control the movable member by using the motor.

The sensor part 121 may include at least one sensor. In detail, the sensor part 121 may include at least one of a tilt sensor sensing a tilt of the electronic apparatus 100 or the image sensor capturing the image. The tilt sensor may be an accelerometer, a gyro sensor, and the image sensor may indicate a camera or the depth camera. The tilt sensor may be described as a motion sensor. The sensor part 121 may include various sensors other than the tilt sensor or the image sensor. For example, the sensor part 121 may include the illuminance sensor or the distance sensor. The distance sensor may be a time of flight (ToF) sensor. The sensor part 121 may include a light detection and ranging (LiDAR) sensor.

The electronic apparatus 100 may control the illumination function by being linked with the external device. In detail, the electronic apparatus 100 may receive illumination information from the external device. The illumination information may include at least one of brightness information or color temperature information, set by the external device. The external device may be a device connected to the same network as the electronic apparatus 100 (e.g., internet of things (IoT) device included in the same home/work network) or a device not connected to the same network as the electronic apparatus 100 and capable of communicating with the electronic apparatus 100 (e.g., remote control server). For example, assume that an external illuminance device (e.g., IoT device) included in the same network as the electronic apparatus 100 outputs red light having a brightness of 50. The external illumination device (e.g., IoT device) may directly or indirectly transmit the illumination information (e.g., information indicating that red light is output with the brightness of 50) to the electronic apparatus 100. The electronic apparatus 100 may control the output of the light source based on the illumination information received from the external illuminance device. For example, the electronic apparatus 100 may output red light with the brightness of 50 in case that the illumination information received from the external illumination device includes the information indicating that red light is output with the brightness of 50.

The electronic apparatus 100 may control the illumination function based on biometric information. In detail, at least one processor 111 may acquire user biometric information. The biometric information may include at least one of the body temperature, heart rate, blood pressure, breath, or electrocardiogram of the user. The biometric information may include various information other than the above-mentioned information. For example, the electronic apparatus 100 may include a sensor measuring the biometric information. At least one processor 111 may acquire the user biometric information from the sensor, and control the output of the light source based on the acquired biometric information. As another example, at least one processor 111 may receive the biometric information from the external device through the input/output interface 116. The external device may be the portable communication device (e.g., smartphone or wearable device) of the user. At least one processor 111 may acquire the user biometric information from the external device, and control the output of the light source based on the acquired biometric information. According to an implementation example, the electronic apparatus 100 may identify whether the user is sleeping, and in case that the user is identified as sleeping (or preparing to sleep), at least one processor 111 may control the output of the light source based on the user biometric information.

The electronic apparatus 100 according to the various embodiments of the present disclosure may provide various smart functions.

In detail, the electronic apparatus 100 may be connected to a portable terminal device controlling the electronic apparatus 100, and the screen output from the electronic apparatus 100 may thus be controlled through the user input that is input from the portable terminal device. For example, the portable terminal device may be implemented as a smartphone including a touch display, the electronic apparatus 100 may receive screen data, provided by the portable terminal device, from the portable terminal device and output the same, and the screen output from the electronic apparatus 100 may be controlled based on the user input that is input from the portable terminal device.

The electronic apparatus 100 may be connected to the portable terminal device by using various communication methods such as miracast, airplay, wireless dalvik executable (DEX) and a remote personal computer (PC) method, and may share content or music, provided by the portable terminal device.

In addition, the portable terminal device and the electronic apparatus 100 may be connected to each other by using various connection methods. In the various embodiments, the portable terminal device may search for the electronic apparatus 100 and perform its wireless connection, or the electronic apparatus 100 may search for the portable terminal device and perform its wireless connection. In addition, the electronic apparatus 100 may output the content provided by the portable terminal device.

In the various embodiments, the portable terminal device may be located near the electronic apparatus 100 while the portable terminal device outputs a specific content or music, and the electronic apparatus 100 may then output the content or music being output by the portable terminal device in case of detecting a predetermined gesture (e.g., motion tap view) through the display of the portable terminal device.

In the various embodiments, the electronic apparatus 100 may output the content or music being output from the portable terminal device in case that the portable terminal device comes closer to the electronic apparatus 100 to a predetermined distance or less (e.g., non-contact tap view) or the portable terminal device comes into contact with the electronic apparatus 100 twice within a short interval (e.g., contact tap view), while the portable terminal device outputs the specific content or music.

In the above-described embodiment, the description describes that the screen provided by the electronic apparatus 100 is the same as the screen provided by the portable terminal device, and the present disclosure is not limited thereto. That is, in case that the connection is established between the portable terminal device and the electronic apparatus 100, a first screen provided by the portable terminal device may be output from the portable terminal device, and a second screen provided by the portable terminal device, which is different from the first screen, may be output from the electronic apparatus 100. For example, the first screen may be a screen provided by a first application installed on the portable terminal device, and the second screen may be a screen provided by a second application installed on the portable terminal device. For example, the first screen and the second screen may be different screens provided by one application installed on the portable terminal device. For example, the first screen may be a screen that includes a remote control-style UI for controlling the second screen.

The electronic apparatus 100 according to the present disclosure may output a standby screen. For example, the electronic apparatus 100 may output the standby screen in case that the electronic apparatus 100 is not connected to the external device or there is no input received from the external device for a predetermined time. A condition for the electronic apparatus 100 to output the standby screen is not limited to the above-described example, and the standby screen may be output based on various conditions.

The electronic apparatus 100 may output the standby screen in the form of a blue screen, and the present disclosure is not limited thereto. For example, the electronic apparatus 100 may acquire an atypical object by extracting only the shape of a specific object from the data received from the external device, and output the standby screen including the acquired atypical object.

The electronic apparatus 100 may further include the display.

The display may be implemented as various types of displays such as a liquid crystal display (LCD), an organic light emitting diode (OLED) display, a plasma display panel (PDP). The display may include a driving circuit, a backlight unit, and the like, which may be implemented in a form such as an amorphous silicon thin film transistor (a-si TFT), a low temperature poly silicon (LTPS) TFT, or an organic TFT (OTFT). The display may be implemented in a touch screen combined with the touch sensor, a flexible display, a three-dimensional (3D) display, or the like. According to the various embodiments of the present disclosure, the display may include a bezel housing the display panel as well as the display panel outputting the image. In particular, the bezel may include the touch sensor detecting user interaction according to the various embodiments of the present disclosure.

The electronic apparatus 100 may further include a shutter part.

The shutter part may include at least one of a shutter, a fixing member, a rail, or a body.

The shutter may block light output from the projection part 112. The fixing member may fix a location of the shutter. The rail may be a path for moving the shutter or the fixing member. The body may be a component including the shutter and the fixing member.

The movable member 122 may be a member moving the electronic apparatus 100 from a first location to a second location in the space where the electronic apparatus 100 is disposed. The electronic apparatus 100 may control the movable member 122 to move the electronic apparatus 100 by using the force generated by the driving part 120. The electronic apparatus 100 may generate the force to be transmitted to the movable member 122 by using the motor included in the driving part 120.

The movable member 122 may include at least one wheel (for example, a circular wheel). The electronic apparatus 100 may be moved to the target location (or target position) by using the movable member. In case of receiving the user input or the control command, the electronic apparatus 100 may rotate the movable member by transmitting the force generated by the motor to the movable member. The electronic apparatus 100 may control the movable member to adjust its rotation speed, rotation direction, or the like. The electronic apparatus 100 may perform a movement operation (or movement function) by controlling the movable member based on the target location, a progress direction, or the like.

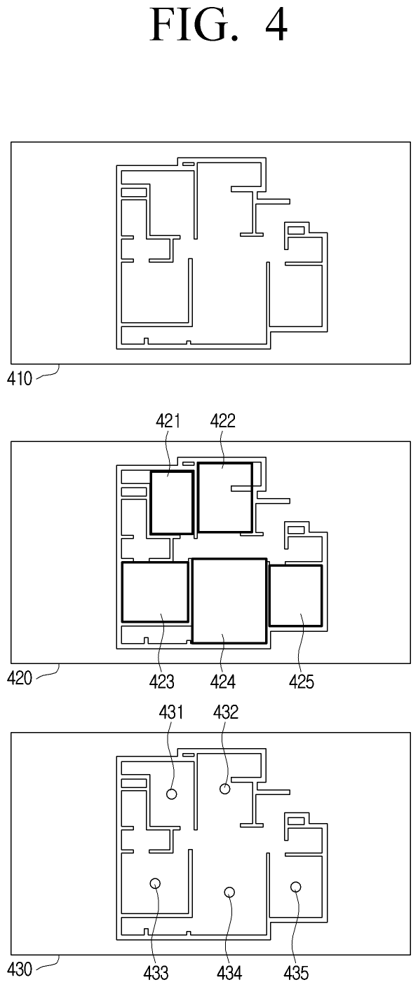

FIG. 4 is a view for explaining an operation of determining the representative location of the space where the electronic apparatus 100 is located according to an embodiment.

Embodiment 410 of FIG. 4 shows the space where the electronic apparatus 100 is disposed. The electronic apparatus 100 may acquire the map data related to the space where the electronic apparatus 100 is disposed.

Embodiment 420 of FIG. 4 shows the plurality of regions in the space where the electronic apparatus 100 is disposed. The electronic apparatus 100 may identify (or distinguish) a plurality of regions 421, 422, 423, 424, and 425 in the space where the electronic apparatus 100 is disposed.

According to Embodiment 430 of FIG. 4, the electronic apparatus 100 may identify a representative location 431, 432, 433, 434, or 435 for each of the plurality of regions 421, 422, 423, 424, and 425. The representative location may include a location indicating (or representing) each region. The electronic apparatus 100 may identify the representative location for each of the plurality of regions 421, 422, 423, 424, and 425. For example, each region may have one representative location. For example, each region may have the plurality of representative locations. For example, the representative location may be the center point of each region.

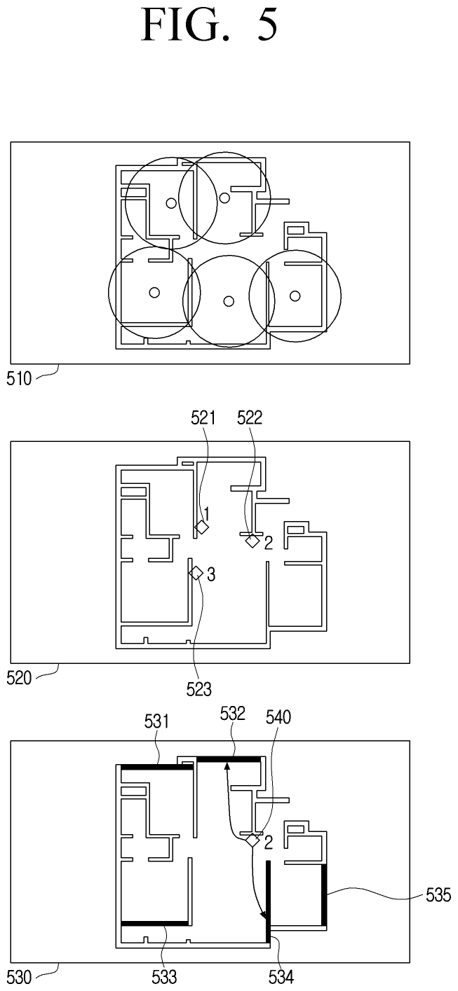

FIG. 5 is a view for explaining an operation of determining the target location in the space where the electronic apparatus 100 is located according to an embodiment.

According to Embodiment 510 of FIG. 5, the electronic apparatus 100 may output the test audio signal in each region. The electronic apparatus 100 may output the test audio signal in each region by considering the representative location.

According to Embodiment 520 of FIG. 5, the electronic apparatus 100 may acquire the recorded audio signal including the output test audio signal. The electronic apparatus 100 may acquire the reverberation time by analyzing the audio signal. The electronic apparatus 100 may determine candidate locations 521, 522, and 523 by analyzing the reverberation time.

According to Embodiment 530 of FIG. 5, the electronic apparatus 100 may determine a target location 540 by using the additional information among the candidate locations 521, 522, and 523. For example, the additional information may include candidate projection surface locations 531, 532, 533, 534, and 535. The electronic apparatus 100 may determine the target location 540, which is the closest on average among the candidate projection surface locations 531, 532, 533, 534, and 535 among the candidate locations 521, 522, and 523.

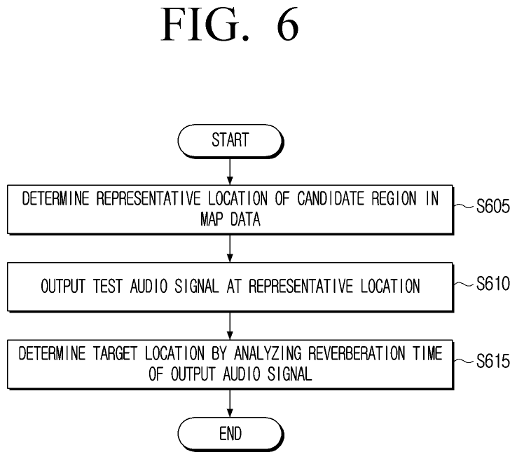

FIG. 6 is a view for explaining an operation of determining the target location according to an embodiment.

Referring to FIG. 6, the electronic apparatus 100 may determine the representative location of the candidate region in the map data (S605). The map data may include the data related to the space where the electronic apparatus 100 is located. For example, the electronic apparatus 100 may pre-store the map data in the memory 113. For example, the electronic apparatus 100 may generate the map data. The electronic apparatus 100 may sense the space where the electronic apparatus 100 is currently located and generate the map data.

The electronic apparatus 100 may identify the candidate region in the map data. The candidate regions may be regions representing the plurality of spaces included in the map data. The candidate region may be a region representing the individual space. For example, assume that there are five rooms in the space where the electronic apparatus 100 is disposed. The candidate region may be a region for each of the five rooms.

The electronic apparatus 100 may specify the location representing the candidate region. The electronic apparatus 100 may identify the representative location representing the candidate region. For example, the representative location may be the center point of the candidate region.

The electronic apparatus 100 may output the test audio signal at the representative location (S610). The electronic apparatus 100 may output the test audio signal through the speaker.

The electronic apparatus 100 may determine the target location by analyzing the reverberation time of the output test audio signal (S615). The electronic apparatus 100 may determine the reverberation time by using an energy change in the test audio signal, and determine the target location by using the determined reverberation time.

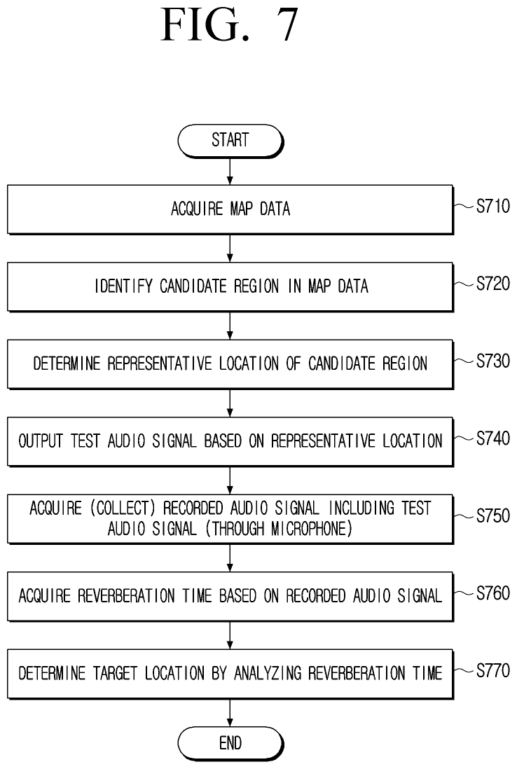

FIG. 7 is a view for explaining an operation of determining the target location by analyzing the reverberation time according to an embodiment.

Referring to FIG. 7, the electronic apparatus 100 may acquire the map data (S710). The electronic apparatus 100 may identify (or determine or acquire) the candidate region in the map data. The electronic apparatus 100 may determine the representative location of the candidate region (S730). A description thereof is described with reference to FIG. 6.

The electronic apparatus 100 may output the test audio signal based on the representative location (S740). The electronic apparatus 100 may determine the location at which the test audio signal is output based on the representative location. The electronic apparatus 100 may output the test audio signal through the speaker 117.

For example, the electronic apparatus 100 may output the test audio signal at the representative location.

For example, the electronic apparatus 100 may output the test audio signal at the representative location, and output the test audio signal while being moved in the candidate region corresponding to the representative location. The electronic apparatus 100 may continuously output the test audio signal.

The electronic apparatus 100 may acquire the recorded audio signal including the test audio signal (S750). The electronic apparatus 100 may acquire the recorded audio signal (or the audio data) through the microphone 118. The acquired recorded audio signal may include the test audio signal.

The electronic apparatus 100 may acquire the reverberation time based on the recorded audio signal (S760). The test audio signal may be reflected at least once by hitting the wall of the space. Each time the audio signal is reflected, the audio signal may be absorbed, thus reducing a magnitude of the audio signal. The electronic apparatus 100 may acquire a magnitude of the test audio signal by using the recorded audio signal. The electronic apparatus 100 may acquire the reverberation time based on the magnitude of the test audio signal. A description thereof is described with reference to FIG. 12.

The electronic apparatus 100 may determine the target location by analyzing the reverberation time (S770). The longer the reverberation time, the higher a recognition rate of the audio signal. The electronic apparatus 100 may determine the target location having the highest recognition rate of the user voice by considering the reverberation time.

FIG. 8 is a view for explaining an operation of determining the candidate region by considering the critical area according to an embodiment.

Referring to FIG. 8, the electronic apparatus 100 may acquire the map data corresponding to its current location (S810). Operation S810 may correspond to operation S710 of FIG. 7. For example, the electronic apparatus 100 may acquire the pre-stored map data based on the predetermined event. For example, the electronic apparatus 100 may generate the map data based on the predetermined event. The electronic apparatus 100 may sense the surrounding environment and generate the map data indicating spatial information.

The electronic apparatus 100 may distinguish (or identify or classify) one or more regions in the map data (S821). At least one region may represent a space surrounded by the walls. For example, if there are five rooms in the space where the electronic apparatus 100 is located, the electronic apparatus 100 may distinguish five regions.

The electronic apparatus 100 may acquire each area of one or more regions (S822). The area may be described as area information. The electronic apparatus 100 may calculate the area of each region.

The electronic apparatus 100 may identify whether a region having an area of the critical area or more exists (S823). If the region having the area of the critical area or more exists (S823-Y), the electronic apparatus 100 may determine the corresponding region as the candidate region (S829).

The electronic apparatus 100 may identify whether each of one or more regions acquired in operation S821 has the critical area or more. The electronic apparatus 100 may determine the region having the area of the critical area or more among one or more regions as the candidate region.

If the region having the area of the critical area or more does not exist, the electronic apparatus 100 may identify the candidate region as not existing.

The electronic apparatus 100 may identify a region having the excessively small area based on a space feature. To avoid an unnecessary calculation process, the electronic apparatus 100 may determine the candidate region by considering the critical area.

FIG. 9 is a view for explaining an operation of determining the candidate region by using a length ratio of the open space according to an embodiment.

Operations S910 and S921 of FIG. 9 may correspond to operations S810 and S821 of FIG. 8.

The electronic apparatus 100 may acquire each perimeter length of one or more regions (S924). The perimeter length may be the total length of the perimeter surrounding the region. For example, the perimeter length of a rectangle may be the sum of lengths of the four sides that form the rectangle.

The electronic apparatus 100 may acquire the length of each open space in one or more regions (S925). The region may be distinguished into the space surrounded by the walls and a space not surrounded by the walls. The space surrounded by the walls may be the closed space. The space not surrounded by the walls may be the open space.

The closed space may be the space where the electronic apparatus 100 is unable to be moved.

The open space may be the space where the electronic apparatus 100 is able to be moved.

The perimeter of the region may include a line corresponding to the closed space and a line corresponding to the open space.

The perimeter length of the region may be the sum of a length of the line corresponding to the closed space and a length of the line corresponding to the open space.

For example, assume that there is one door disposed in a rectangular room. The total perimeter length of the rectangular room may be the sum of a length of the door and horizontal lengths of the walls excluding the door.

The electronic apparatus 100 may acquire a ratio of the length of the open space to the perimeter length (S926). The ratio may be described as the ratio information. The electronic apparatus 100 may acquire the ratio based on the perimeter length of the region and the length of the open space. The electronic apparatus 100 may acquire the ratio (or ratio value) by dividing the perimeter length of the region by the length of the open space. The electronic apparatus 100 may acquire the ratio of the length of the open space to the total perimeter length of the region.

The electronic apparatus 100 may identify whether the ratio is less than the critical ratio (S927). The higher the ratio, the higher the proportion occupied by the open space. If the ratio indicated by the open space is high, the electronic apparatus 100 may recognize the corresponding space as the open space.

If the ratio is less than the critical ratio (S927-Y), the electronic apparatus 100 may determine the corresponding region as the candidate region (S929).

If the ratio is not less than the critical ratio (S927-N), the electronic apparatus 100 may identify the candidate region as not existing.

FIG. 10 is a view for explaining an operation of determining the candidate region by using the critical area and the length ratio of the open space according to an embodiment.

Operations S1010, S1021, S1022, and S1023 of FIG. 10 may correspond to operations S810, S821, S822, and S823 of FIG. 8. The description omits their redundant descriptions.

Operations S1024, S1025, S1026, S1027, and S1029 of FIG. 10 may correspond to operations S924, S925, S926, S927, and S929 of FIG. 9. The description omits their redundant descriptions.

The electronic apparatus 100 may identify whether the distinguished region has the critical area or more at operation S1021. If the distinguished region has the critical area or more, the electronic apparatus 100 may acquire the perimeter length of the distinguished region (S1024). The electronic apparatus 100 may identify the length of the open space in the distinguished region (S1025). The electronic apparatus 100 may acquire the ratio by dividing the perimeter length by the length of the open space (S1026).

The electronic apparatus 100 may identify whether the ratio is the critical ratio or more (S1027). If the ratio is smaller than the critical ratio, the electronic apparatus 100 may determine the distinguished region as the candidate region (S1029).

FIG. 11 is a view for explaining an operation of acquiring the reverberation time according to an embodiment.

Referring to FIG. 11, the operations of FIG. 11 may correspond to operation S760 of FIG. 7. The description omits their redundant descriptions.

The electronic apparatus 100 may identify the test audio signal (S1161). The electronic apparatus 100 may acquire the test audio signal to be output through the speaker 117.

The electronic apparatus 100 may be moved to the representative location of the candidate region (S1162). The electronic apparatus 100 may output the test audio signal based on the representative location (S1163). The electronic apparatus 100 may output the test audio signal through the speaker 117.

The electronic apparatus 100 may acquire the recorded audio signal including the test audio signal (S1164). The electronic apparatus 100 may collect (or acquire) the surrounding audio signal through the microphone 118.

The electronic apparatus 100 may acquire the first volume of the test audio signal at the first time point based on the recorded audio signal (S1165). The first time point may correspond to a time point at which the test audio signal is output. The first time point may be the critical time (for example, 0.5 seconds) from the time point at which the test audio signal is output. The electronic apparatus 100 may identify the magnitude of the test audio signal included in the recorded audio signal at the first time point. The magnitude of the signal acquired at the first time point may correspond to the direct sound. The direct sound may correspond to a direct wave. The volume of the test audio signal acquired at the first time point may be an initial volume or an original volume.

The electronic apparatus 100 may identify the second volume acquired by multiplying the first volume by the reverberation ratio (S1166). The reverberation ratio may be a predetermined ratio. The reverberation ratio may be a ratio that serves as a reference for indicating the reverberation time. For example, the reverberation ratio may be 20%. The reverberation time may be a time taken for the audio signal to be decreased by 20% from the initial volume. The reverberation ratio may be changed based on the user setting. The electronic apparatus 100 may acquire the second volume by multiplying the first volume by the predetermined reverberation ratio.

The test audio signal may have its energy reduced by air or the wall over time. The energy of the test audio signal may be reduced each time the test audio signal is reflected from the wall, or the like. As the energy of the test audio signal is reduced, the volume of the test audio signal may be reduced. The energy of the audio may be reduced because the number of times the audio is reflected from various walls, or the like is increased over time.

The electronic apparatus 100 may acquire the second time point at which the test audio signal has the second volume (S1167). The electronic apparatus 100 may analyze the recorded audio signal to thus identify whether the volume of the test audio signal has the second volume. The electronic apparatus 100 may analyze the recorded audio signal to thus determine the time point at which the test audio signal has the second volume as the second time point.

The electronic apparatus 100 may acquire (or calculate) the reverberation time based on the difference between the first time point and the second time point (S1168).

FIG. 12 is a view for explaining the reverberation time according to an embodiment.

Embodiment 1210 of FIG. 12 shows a situation of outputting the test audio signal in a first space 1211. The electronic apparatus 100 may output the test audio signal having a first volume V1 at a first time point t1. The electronic apparatus 100 may acquire the volume of the test audio signal by acquiring the recorded audio signal.

Referring to Table 1212, the electronic apparatus 100 may acquire the volume of the test audio signal based on the recorded audio signal. The electronic apparatus 100 may acquire a second volume V2 by multiplying the first volume V1 by the reverberation ratio. The electronic apparatus 100 may acquire a second time point t2 at which the volume of the test audio signal has the second volume V2. The electronic apparatus 100 may determine a difference between the first time point t1 and the second time point t2 as the reverberation time.

Embodiment 1220 of FIG. 12 shows a situation of outputting the test audio signal in a second space 1221. The electronic apparatus 100 may output the test audio signal having the first volume V1 at the first time point t1. The electronic apparatus 100 may acquire the volume of the test audio signal by acquiring the recorded audio signal.

Referring to Table 1222, the electronic apparatus 100 may acquire the volume of the test audio signal based on the recorded audio signal. The electronic apparatus 100 may acquire the second volume V2 by multiplying the first volume V1 by the reverberation ratio. The electronic apparatus 100 may acquire a third time point t3 at which the volume of the test audio signal has the second volume V2. The electronic apparatus 100 may determine a difference between the first time point t1 and the third time point t3 as the reverberation time.

An area of the space 1221 in Embodiment 1220 may be larger than an area of the space 1211 in Embodiment 1210. If the space is larger, a time taken for the audio signal to be reflected and returned may be increased. In an ideal situation, the same ratio of energy may be lost in case that the audio signal is reflected by the wall or the like. The reverberation time acquired in the space 1221 may be longer than the reverberation time acquired in the space 1211. In similar environments, the larger the space size, the longer the reverberation time.

FIG. 13 is a view for explaining an operation of determining the target location by using the reverberation time according to an embodiment.

Referring to FIG. 13, the electronic apparatus 100 may acquire the reverberation time at the plurality of locations (S1360). Operation S1360 may correspond to operation S760 of FIG. 7. The description omits its redundant description.

The electronic apparatus 100 may identify whether the reverberation time is the critical time or more (S1371). If the reverberation time is not the critical time or more (S1371-N), the electronic apparatus 100 may not determine the location where the reverberation time is measured as the candidate location.

If the reverberation time is the critical time or more (S1371-Y), the electronic apparatus 100 may determine the location that has the reverberation time of the critical time or more as the candidate location (S1372). The electronic apparatus 100 may identify an edge location among the locations in the specific region, where the reverberation time is measured. The electronic apparatus 100 may determine, as the candidate location, the edge location that has the reverberation time of the critical time or more among the plurality of edge locations. The edge location may be the location of a line indicating the perimeter of the region.

The candidate location may be a location filtered from all the locations where the reverberation time is measured. The electronic apparatus 100 may simplify a calculation process in determining the target location by determining some filtered locations as the candidate locations instead of all the locations.

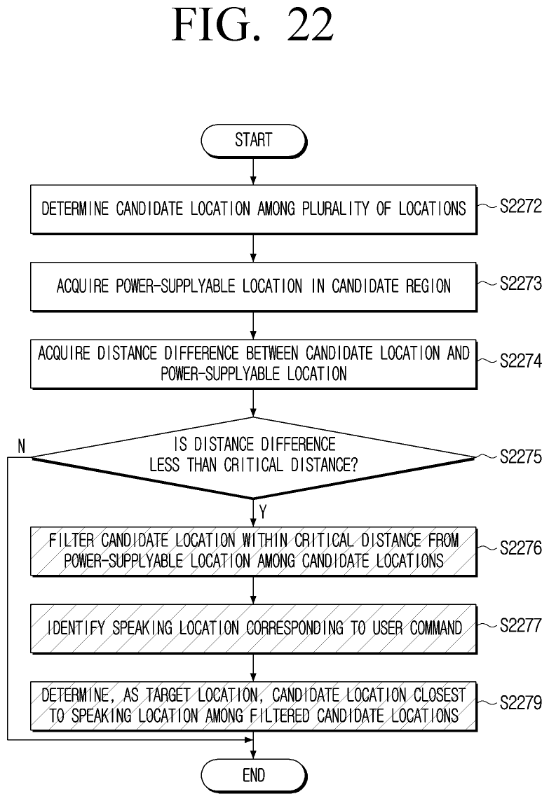

The electronic apparatus 100 may determine the target location among the candidate locations based on the additional information (S1373). The additional information may include an outlet location, the candidate projection surface location, the speaking location, or the like. The description describes an operation related to the outlet location with reference to FIG. 14. The description describes the candidate projection surface location with reference to FIG. 15. The description describes the speaking location with reference to FIG. 22.

FIG. 14 is a view for explaining an operation of determining the target location by considering the power-supplyable location according to an embodiment.

Operations S1460, S1471, and S1472 of FIG. 14 may correspond to operations S1360, S1371, and S1372 of FIG. 13. The description omits their redundant descriptions.

In case of determining the candidate location, the electronic apparatus 100 may acquire the power-supplyable location in the candidate region (S1473). The power-supplyable location may include the location of an outlet that may receive power.

The electronic apparatus 100 may acquire the distance difference between the candidate location and the power-supplyable location (S1474). The electronic apparatus 100 may identify whether the distance difference is less than the critical distance (S1475).

If the distance difference is less than the critical distance (S1475-Y), the electronic apparatus 100 may determine, as the target location, the candidate location closest to the power supply location among the candidate locations (51476).

If the plurality of candidate locations are provided, the electronic apparatus 100 may determine whether each of the plurality of candidate locations is within the critical distance from the power-supplyable location. The electronic apparatus 100 may determine, as the target location, the candidate location closest to the power-supplyable location among the plurality of candidate locations.

If the plurality of power-supplyable locations are provided, the electronic apparatus 100 may acquire the distance difference between the power-supplyable location and the candidate location based on each of the power-supplyable locations. The electronic apparatus 100 may determine the candidate location having the lowest average distance difference as the target location.

For example, the power-supplyable location may be different for each candidate region.

For example, the candidate region may have the plurality of power-supplyable locations.

FIG. 15 is a view for explaining an operation of determining the target location by considering the candidate projection surface location according to an embodiment.

Operations S1560, S1571, and S1572 of FIG. 15 may correspond to operations S1360, S1371, and S1372 of FIG. 13. The description omits their redundant descriptions. In Embodiment of FIG. 15, the electronic apparatus 100 may be a device (for example, the projector) that performs a projection function of outputting the projection image.

In case of determining the candidate location, the electronic apparatus 100 may identify the candidate projection surface in the candidate region (S1577). The candidate projection surface may be the projection surface on which the projection image may be output. The electronic apparatus 100 may determine, as the candidate projection surface, the wall having the critical area or more among the walls of the candidate region. The candidate projection surface may be a portion of one wall. The reason is that an obstacle (for example, a clock or a wardrobe) may be disposed on the wall.

The electronic apparatus 100 may identify the candidate projection surface location (S1578). The electronic apparatus 100 may identify the candidate projection surface location in the map data. The electronic apparatus 100 may map the candidate projection surface location in the map data.

The electronic apparatus 100 may determine, as the target location, the candidate location closest to the candidate projection surface location among the candidate locations (S1579).

If the plurality of candidate locations are provided, the electronic apparatus 100 may determine, as the target location, the candidate location closest to the candidate projection surface location among the plurality of candidate locations.

If the plurality of candidate projection surfaces are provided, the electronic apparatus 100 may acquire a distance difference between the candidate projection surface location and the candidate location based on each of the candidate projection surfaces. The electronic apparatus 100 may determine the candidate location having the lowest average distance difference as the target location.

For example, the candidate projection surface location may be different for each candidate region.

For example, the candidate region may have the plurality of candidate projection surface locations.

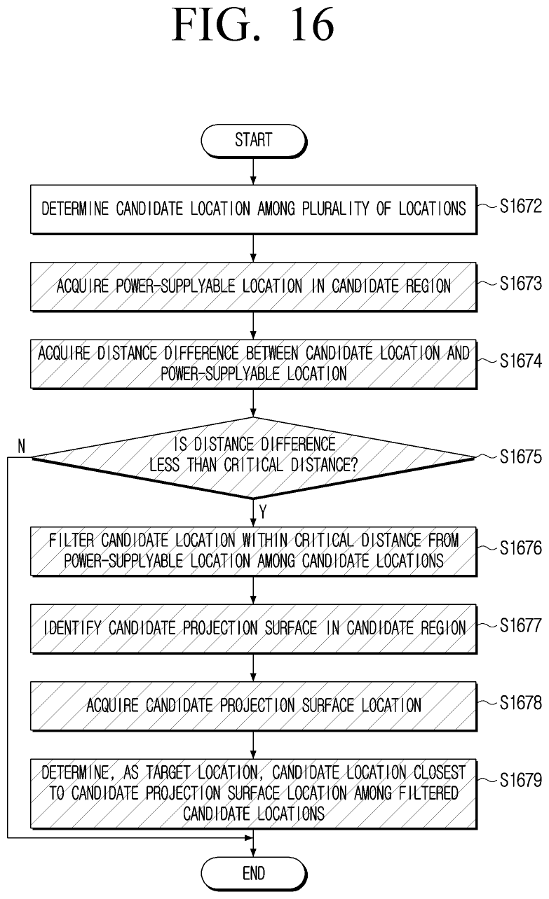

FIG. 16 is a view for explaining an operation of determining the target location by considering the power-supplyable location and the candidate projection surface location according to an embodiment.

Operations S1672, S1673, S1674, and S1675 of FIG. 16 may correspond to operations S1472, S1473, S1474, and S1475 of FIG. 14. The description omits their redundant descriptions.

Operations S1676, S1677, S1678, and S1679 of FIG. 16 may correspond to operations S1576, S1577, S1578, and S1579 of FIG. 15. The description omits their redundant descriptions.

If the distance difference between the candidate location and the power-supplyable location is less than the critical distance (S1675-Y), the electronic apparatus 100 may filter the candidate location within the critical distance from the power-supplyable location among the candidate locations (S1676).

The electronic apparatus 100 may identify the candidate projection surface in the candidate region (S1677). The electronic apparatus 100 may acquire the candidate projection surface location (S1678).

The electronic apparatus 100 may determine, as the target location, the candidate location closest to the candidate projection surface location among the candidate locations filtered in operation S1676.

In case that the plurality of candidate locations, the plurality of power-supplyable locations, and the plurality of candidate projection surface locations are provided, the electronic apparatus 100 may determine the target location by using each location or each average distance difference. The description thereof is provided with reference to FIGS. 14 and 15.

FIG. 17 is a view for explaining a screen for providing the target location according to an embodiment.

Referring to FIG. 17, the electronic apparatus 100 may provide a screen 1700 related to the target location (for example, the charging location). The electronic apparatus 100 may provide the screen 1700 through the display.

The screen 1700 may include at least one of a UI 1710 including a text indicating the recommended target location (for example, the charging location) or a UI 1720 including the map data indicating the target location (for example, the charging location).

The UI 1720 may include the map data indicating at least one of the current location of the electronic apparatus 100 or the target location (for example, the charging location).

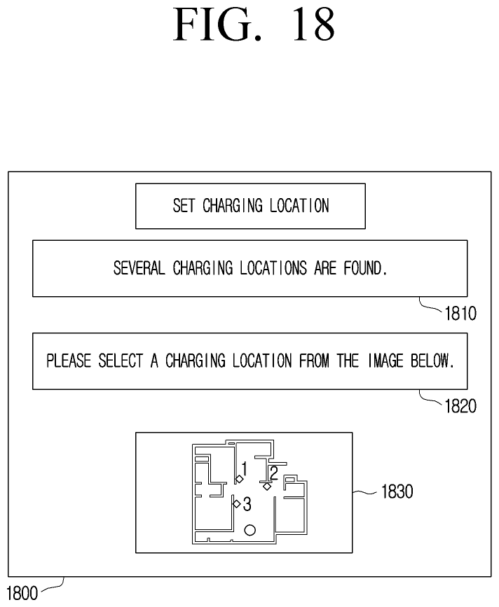

FIG. 18 is a view for explaining a screen for selecting the target location according to an embodiment.

Referring to FIG. 18, the electronic apparatus 100 may provide a screen 1800 guiding selection of the target location (for example, the charging location).

The screen 1800 may include at least one of a UI 1810 indicating that the plurality of target locations (for example, the charging location) are searched for, a UI 1820 guiding the selection of the target location (for example, the charging location), or a UI 1830 including the map data.

The UI 1830 may include the map data indicating at least one of the current location of the electronic apparatus 100 or the plurality of target locations (for example, the charging locations).

Assuming that one target location (for example, the charging location) is ultimately determined, the electronic apparatus 100 may be described as determining one target location (for example, the charging location) among the plurality of candidate locations.

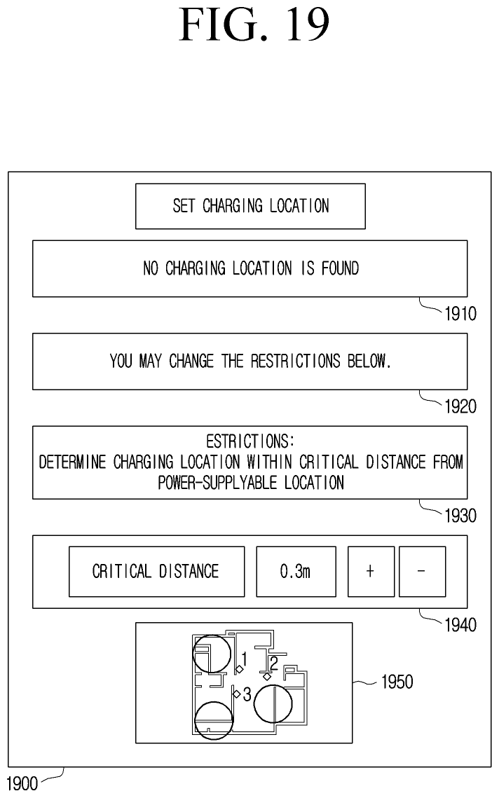

FIG. 19 is a view for explaining a screen related to setting the target location according to an embodiment.

Referring to FIG. 19, the electronic apparatus 100 may provide a screen 1900 related to a function of setting the target location (for example, the charging location). At least one restriction information may be used to determine the target location (for example, the charging location).

The restriction information may include various types of information used to determine the target location (for example, the charging location). The limitation information may be described as critical information. The restriction information may include at least one of the critical area described in FIG. 8, the critical ratio described with reference to FIG. 9, the critical time described with reference to FIG. 13, or the critical distance described with reference to FIG. 14. The specific drawing is only an example, and is not limited to describing the restriction information. The restriction information may also be used in another drawing.

The electronic apparatus 100 may determine the target location (for example, the charging location) by using the restriction information. The electronic apparatus 100 may change the restriction information based on the predetermined event.

For example, the electronic apparatus 100 may change the restriction information based on the user input. For example, the electronic apparatus 100 may change the critical distance from 0.3 m to 0.45 m.

For example, the electronic apparatus 100 may change the restriction information based on the predetermined ratio. For example, the electronic apparatus 100 may change the critical distance to a value (0.45 m) that is increased by the critical ratio (50%) of 0.3 m. The predetermined ratio may be a ratio intended to further identify the target location (for example, the charging location) by changing the restriction information. The electronic apparatus 100 may relax restrictions based on the predetermined ratio.

The electronic apparatus 100 may be unable to identify the target location (for example, the charging location). If an event occurs where the target location (for example, the charging location) is not identified, the electronic apparatus 100 may provide the screen 1900.

The screen 1900 may include at least one of a UI 1910 indicating that the target location (for example, the charging location) is not identified, a UI 1920 guiding the user to change the restrictions, a UI 1930 describing the restrictions, a UI 1940 indicating specific settings for the restrictions, or a UI 1950 including the map data indicating the restrictions.

FIG. 20 is a view for explaining an operation of determining the target location by considering a user speaking history according to an embodiment.

In Embodiment 2010 of FIG. 20, the user speaking location may be acquired in the space where the electronic apparatus 100 is located. The electronic apparatus 100 may receive the user voice. In case of receiving the user voice, the electronic apparatus 100 may identify the location where the user voice is spoken. The electronic apparatus 100 may include the plurality of microphones. The electronic apparatus 100 may identify the location where the user voice is spoken based on the same user voice received from the plurality of microphones.

The user voice may be a command to call the electronic apparatus 100. The electronic apparatus 100 may not store the speaking location for all the user voices. The electronic apparatus 100 may identify the speaking location only for the user voice related to the control of the electronic apparatus 100.

The electronic apparatus 100 may identify the location where the received user voice is spoken in case of receiving the user voice including at least one of the wake up word related to the voice recognition of the electronic apparatus 100 or the control command to perform the control operation of the electronic apparatus 100. The electronic apparatus 100 may accumulate and store the speaking locations. The electronic apparatus 100 may map and store the speaking location in the map data.

Embodiment 2020 of FIG. 20 may indicate that the target location is changed based on the speaking location related to the user voice. The target location determined first may be a first target location 2021. After the first target location is determined, the electronic apparatus 100 may accumulate the speaking locations of the user voice during the critical period and store the same in the map data. The electronic apparatus 100 may change the target location from the first target location 2021 to a second target location 2022 by considering the speaking location after the critical period elapses.

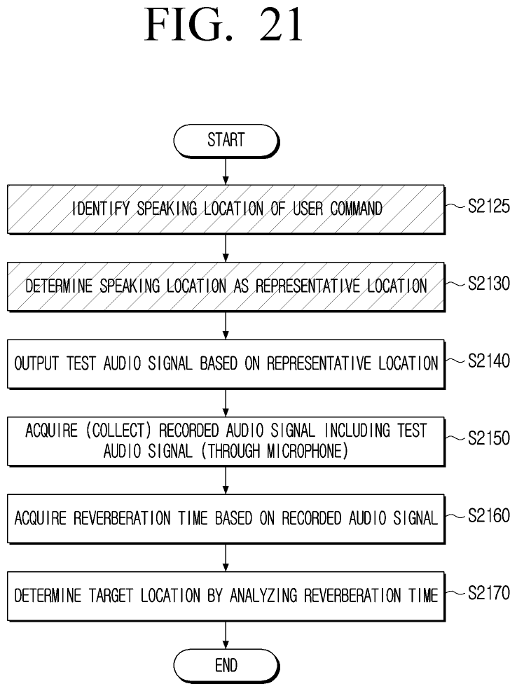

FIG. 21 is a view for explaining an operation of outputting the test audio signal by considering the speaking location according to an embodiment.

Operations S2140, S2150, S2160, and S2170 of FIG. 21 may correspond to operations S740, S750, S760, and S770 of FIG. 7. The description omits their redundant descriptions.

The electronic apparatus 100 may identify the speaking location of the user command (S2125). In case of receiving the user command, the electronic apparatus 100 may identify the speaking location where the user command is spoken.

The electronic apparatus 100 may determine the speaking location as the representative location (S2130). The electronic apparatus 100 may output the test audio signal based on the representative location (S2140). The electronic apparatus 100 may perform operations S2150, S2160, and S2170.

FIG. 22 is a view for explaining an operation of determining the target location by considering the speaking location according to an embodiment.

Operations S2272, S2273, S2274, and S2275 of FIG. 22 may correspond to operations S1472, S1473, S1474, and S1475 of FIG. 14. The description omits their redundant descriptions.

If the distance difference between the candidate location and the power-supplyable location is less than the critical distance (S2275-Y), the electronic apparatus 100 may filter the candidate location within the critical distance from the power-supplyable location among the candidate locations (S2276).

The electronic apparatus 100 may identify the speaking location corresponding to the user command (S2277). The electronic apparatus 100 may determine, as the target location, the candidate location closest to the speaking location among the candidate locations filtered in operation S2276.

The plurality of speaking locations may be provided. For example, the electronic apparatus 100 may identify an average speaking location of the plurality of speaking locations, and determine the target location based on the identified average speaking location. The electronic apparatus 100 may determine, as the target location, the candidate location closest to the average speaking location among the filtered candidate locations (S2279).

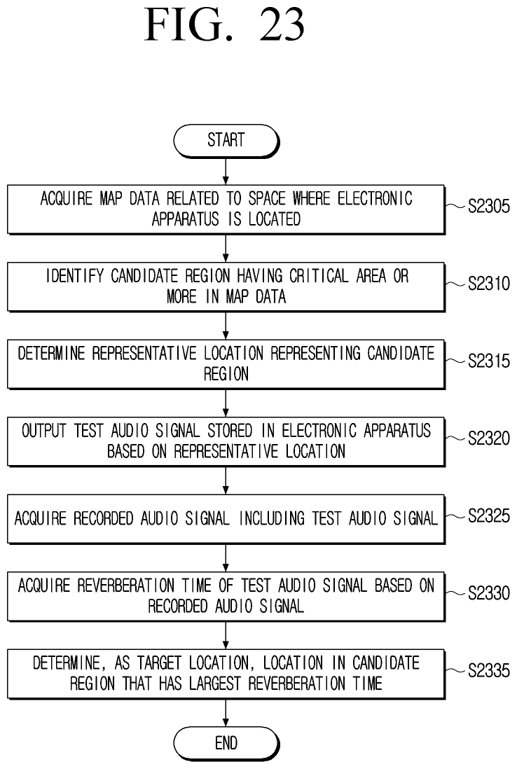

FIG. 23 is a view for explaining a controlling method of an electronic apparatus 100 according to an embodiment.

Referring to FIG. 23, the controlling method of an electronic apparatus includes: acquiring map data related to a space where the electronic apparatus is located (S2305); identifying a candidate region having a critical area or more in the map data (S2310); determining a representative location representing the candidate region (S2315); outputting a test audio signal stored in the electronic apparatus based on the representative location (S2320); acquiring a recorded audio signal including the test audio signal (S2325); acquiring a reverberation time of the test audio signal based on the recorded audio signal (S2330); determining, as a target location, a location in the candidate region that has the largest reverberation time (S2335); and providing the target location.

In the identifying of the candidate region (S2310), the map data may be distinguished into the plurality of regions, the region having the critical area or more among the plurality of regions may be determined as the candidate region, and in the determining of the target location (S2335), the target location may be determined in the candidate region.

In the identifying of the candidate region (S2310), a perimeter length of a first region having the critical area or more may be acquired, a length corresponding to an open space in the first region may be acquired, a ratio of the open space may be acquired by dividing the length corresponding to the open space by the perimeter length, and the first region may be determined as the candidate region if the ratio of the open space is less than a critical ratio.

In the acquiring of the reverberation time (S2330), a first volume of the test audio signal may be acquired at a first time point based on the recorded audio signal after the test audio signal is output, and a second volume may be acquired by multiplying the first volume by a predetermined reverberation ratio, a second time point may be acquired at which the volume of the test audio signal becomes the second volume, and the reverberation time may be acquired based on a difference between the first time point and the second time point.

In the determining of the target location (S2335), a location in the candidate region that has the reverberation time of a critical time or more may be determined as a candidate location, and the target location may be determined based on the candidate location and additional information.

The additional information may include a power-supplyable location for connecting power to the electronic apparatus, and in the determining of the target location (S2335), a distance difference between the candidate location and the power-supplyable location may be acquired, the candidate location closest to the power-supplyable location among the plurality of candidate locations where the distance difference is less than a critical distance may be determined as the target location.

The additional information may include a candidate projection surface location related to output of a projection image, and in the determining of the target location (S2335), the candidate location closest to the candidate projection surface location may be determined as the target location.

The recorded audio signal may be a first recorded audio signal, the target location may be a first target location, and the controlling method may further include: identifying a speaking location of a user command during a critical period; outputting the test audio signal based on the speaking location; acquiring a second recorded audio signal including the test audio signal; acquiring the reverberation time of the test audio signal based on the second recorded audio signal; and determining the location in the candidate region that has the largest reverberation time as a second target location, wherein the second target location is different from the first target location.

The controlling method may further include displaying a user interface (UI) that includes the map data representing the target location.

According to the controlling method, the electronic apparatus 100 may be moved to the target location if a predetermined event occurs.

The methods according to the various embodiments of the present disclosure described above may be implemented in the form of an application which may be installed in a conventional electronic apparatus.

The methods according to the various embodiments of the present disclosure described above may be implemented only by software upgrade or hardware upgrade of the conventional electronic apparatus.

The various embodiments of the present disclosure described above may be performed through an embedded server included in the electronic apparatus, or an external server of at least one of the electronic apparatus and the display device.

According to an embodiment of the present disclosure, the various embodiments described above may be implemented by software including an instruction stored in a machine-readable storage medium (for example, a computer-readable storage medium). A machine may be a device that invokes the stored instruction from the storage medium, may be operated based on the invoked instruction, and may include the electronic apparatus in the disclosed embodiments. In case that the instruction is executed by the processor, the processor may perform a function corresponding to the instruction directly or by using another component under control of the processor. The instruction may include a code provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

According to an embodiment of the present disclosure, the methods according to the various embodiments described above may be provided by being included in a computer program product. The computer program product may be traded as a product between a seller and a purchaser. The computer program product may be distributed in a form of the machine-readable storage medium (for example, a compact disc read only memory (CD-ROM)) or online through an application store (for example, PlayStore™). In case of the online distribution, at least some of the computer program products may be at least temporarily stored in a storage medium such as a memory of a server of a manufacturer, a server of an application store, or a relay server, or be temporarily generated.

Each of the components (for example, modules or programs) according to the various embodiments described above may include one entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs or other components according to the various embodiments may be executed in a sequential manner, a parallel manner, an iterative manner or a heuristic manner, at least some of the operations may be performed in a different order or be omitted, or other operations may be added.

Although the embodiments are shown and described in the present disclosure as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
a speaker;
a microphone; and
at least one processor configured to:
identify a candidate region having a critical area or more area than the critical area in map data related to a space where the electronic apparatus is located,
move the electronic apparatus to a representative location of the candidate region and output an audio signal through the speaker,
acquire a reverberation time of the audio signal at a plurality of locations including the representative location in the candidate region based on a recorded audio signal corresponding to the audio signal acquired through the microphone, and
identify a target location from which a longest reverberation time is acquired among the plurality of locations.

2. The electronic apparatus as claimed in claim 1, wherein the at least one processor is configured to:
identify, as the candidate region, a region in the map data that has the critical area or more area than the critical area among a plurality of regions, and
identify the target location in the candidate region.

3. The electronic apparatus as claimed in claim 2, wherein the at least one processor is configured to:
acquire a perimeter length of a first region having the critical area or more area than the critical area,
acquire a length corresponding to an open space in the first region, and
identify the first region as the candidate region based on the length corresponding to the open space divided by the perimeter length to acquire a ratio of the open space being less than a critical ratio.

4. The electronic apparatus as claimed in claim 1, wherein the at least one processor is configured to:
acquire a first volume of the audio signal at a first time point based on the recorded audio signal after outputting the audio signal,
acquire a second volume by multiplying the first volume by a predetermined reverberation ratio,
acquire a second time point at which the audio signal is at the second volume, and
acquire the reverberation time based on a difference between the first time point and the second time point.

5. The electronic apparatus as claimed in claim 4, wherein the at least one processor is configured to:
identify a candidate location that has the reverberation time of a critical time or more time than the critical time among the plurality of locations, and
identify the target location based on the candidate location and additional information.

6. The electronic apparatus as claimed in claim 5, wherein the additional information includes a power-supplyable location to connect power to the electronic apparatus, and
the at least one processor is configured to identify the target location based on the candidate location, which is closest to the power-supplyable location among a plurality of candidate locations, where a distance difference between the candidate location and the power-supplyable location is less than a critical distance.

7. The electronic apparatus as claimed in claim 5, wherein the additional information includes a candidate projection surface location related to output of a projection image, and
the at least one processor is configured to identify, as the target location, the candidate location closest to the candidate projection surface location.

8. The electronic apparatus as claimed in claim 1, wherein the recorded audio signal is a first recorded audio signal, the target location is a first target location, and
the at least one processor is configured to
identify a speaking location of a user command during a critical period,
output the audio signal through the speaker based on the speaking location,
acquire a second recorded audio signal including the audio signal through the microphone,
acquire the reverberation time of the audio signal based on the second recorded audio signal, and
identify a second target location that has the longest reverberation time among the plurality of locations,
wherein the second target location is different from the first target location.

9. The electronic apparatus as claimed in claim 1, further comprising a display,
wherein the at least one processor is configured to control the display to display a user interface (UI) including the map data indicating the target location.

10. The electronic apparatus as claimed in claim 1, wherein the at least one processor is configured to move the electronic apparatus to the target location based on a predetermined event occurring.

11. A controlling method of an electronic apparatus, the controlling method comprising:
identifying a candidate region having a critical area or more area than the critical area in map data related to a space where the electronic apparatus is located;
moving the electronic apparatus to a representative location of the candidate region and outputting an audio signal;
acquiring a recorded audio signal corresponding to the audio signal at a plurality of locations in the candidate region;
acquiring a reverberation time of the audio signal at the plurality of locations including the representative location in the candidate region based on the recorded audio signal; and
identifying a target location from which a longest reverberation time is acquired among the plurality of locations.

12. The controlling method as claimed in claim 11, wherein in the identifying of the candidate region, a region in the map data that has the critical area or more area than the critical area among a plurality of regions is identified as the candidate region, and
in the identifying of the target location, the target location is identified in the candidate region.

13. The controlling method as claimed in claim 12, wherein in the identifying of the candidate region,
a perimeter length of a first region having the critical area or more area than the critical area is acquired,
a length corresponding to an open space in the first region is acquired, and
the first region is identified as the candidate region based on the length corresponding to the open space being divided by the perimeter length to acquire a ratio of the open space that is less than a critical ratio.

14. The controlling method as claimed in claim 11, wherein in the acquiring of the reverberation time,
a first volume of the audio signal is acquired at a first time point based on the recorded audio signal after the audio signal is output,
a second volume is acquired by multiplying the first volume by a predetermined reverberation ratio,
a second time point is acquired at which the audio signal is at the second volume, and
the reverberation time is acquired based on a difference between the first time point and the second time point.

15. The controlling method as claimed in claim 14, wherein in the identifying of the target location, the target location is identified as having the reverberation time of a critical time or more time than the critical time among the plurality of locations, and
the target location is identified based on the candidate location and additional information.
